(19) United States
(12) Patent Application Publication
(10) Pub. No.: US 2026/0127052 A1
(43) Pub. Date: May 7, 2026

(54) APPLICATION PROGRAMMING INTERFACE (API) ACCESS FOR INTERCONNECTED API FRAMEWORK CORE FUNCTIONS

(71) Applicant: Lenovo (United States) Inc., Morrisville, NC (US)

(72) Inventors: Sheeba Backia Mary Baskaran, Friedrichsdorf (DE); Andreas Kunz, Ladenburg (DE)

(73) Assignee: Lenovo (United States) Inc., Morrisville, NC (US)

(21) Appl. No.: 18/935,117

(22) Filed: Nov. 1, 2024

(51) Int. Cl. G06F 9/54

(52) U.S. Cl. CPC G06F 9/547

(57) ABSTRACT

Various aspects of the present disclosure relate to application programming interface (API) access for interconnected API framework core functions (CCFs) for wireless communication. A device implements a first CCF that is interconnected with a second CCF. The device obtains an indication that one or more service APIs are associated with the second CCF and receives a request to onboard an API invoker to access at least one service API of one or more service APIs associated with the first CCF or the service APIs associated with the second CCF. The service APIs associated with the first CCF and the second CCF correspond to respective CCF addresses or respective CCF identifiers (IDs). The device transmits a response to the request that indicates one or more of the respective CCF addresses or the respective CCF IDs corresponding to the service APIs associated with the first CCF and the second CCF.

### TECHNICAL FIELD

The present disclosure relates to wireless communications, and more specifically to application programming interface (API) exposure and access.

### BACKGROUND

A wireless communications system may include one or multiple network communication devices, such as base stations, which may support wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers, or the like)). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

The wireless communications system may support wireless communications, and may include one or more devices, such as UEs, base stations (e.g., gNBs), network entities, satellites, and/or network equipment (NE), among other devices, that transmit and/or receive signaling.

### SUMMARY

An article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.” Further, as used herein, including in the claims, a “set” may include one or more elements.

Some implementations of the method and apparatuses described herein may include a device to implement a first common application programming interface framework core function (CCF) for wireless communication to obtain, based on a connection between the first CCF and a second CCF, an indication that one or more service application programming interfaces (APIs) are associated with the second CCF, receive a request to onboard an API invoker to access at least one service API of one or more service APIs associated with the first CCF or the one or more service APIs associated with the second CCF, where the one or more service APIs associated with the first CCF and the one or more service APIs associated with the second CCF correspond to respective CCF addresses or respective CCF identifiers (IDs), and transmit a response to the request that indicates one or more of the respective CCF addresses or the respective CCF IDs corresponding to the one or more service APIs associated with the first CCF and the one or more service APIs associated with the second CCF.

In some implementations of the method and apparatuses described herein, the device stores, at the first CCF, one or more of the respective CCF addresses or the respective CCF IDs corresponding to the one or more service APIs associated with the first CCF and the one or more service APIs associated with the second CCF, one or more additional respective CCF addresses or one or more additional respective CCF IDs corresponding to one or more application exposure functions (AEFs) associated with the second CCF, service API information corresponding to the one or more service APIs associated with the first CCF, service API information corresponding to the one or more service APIs associated with the second CCF, AEF information corresponding to the AEFs associated with the first CCF, or AEF information corresponding to the AEFs associated with the second CCF.

Additionally, or alternatively, to transmit the response to the request, the device generates a profile associated with the API invoker, where the profile indicates a method for the API invoker to authenticate and authorize one or more AEFs. Additionally, or alternatively, the one or more AEFs are associated with the second CCF, and where the response includes one or more of AEF information associated with the one or more AEFs, additional respective CCF addresses or additional respective CCF IDs corresponding to the one or more AEFs, respective security methods corresponding to the one or more AEFs, or additional respective security methods corresponding to the one or more service APIs associated with the second CCF. Additionally, or alternatively, the profile includes a certificate associated with the API invoker for subsequent authentication procedures with the first CCF and for establishing a connection with the one or more AEFs.

Additionally, or alternatively, the response includes one or more of an ID assigned to the API invoker by the first CCF, additional respective CCF addresses or additional respective CCF IDs corresponding to one or more AEFs associated with at least one of the first CCF or the second CCF, a root certificate to validate one or more server certificates corresponding to the one or more AEFs, a certificate associated with the API invoker, and an onboard secret associated with the API invoker. Additionally, or alternatively, the first CCF and the second CCF are associated with different trust domains. Additionally, or alternatively, the first CCF and the second CCF are associated with a same trust domain. Additionally, or alternatively, the first CCF and the second CCF are associated with different common application programming interface framework (CAPIF) providers. Additionally, or alternatively, the first CCF and the second CCF are associated with a same CAPIF provider.

Some implementations of the method and apparatuses described herein may further include a device to implement an API invoker for wireless communication to establish a connection between the API invoker and a first CCF, transmit a request to onboard the API invoker to access at least one of one or more service APIs associated with the first CCF or one or more service APIs associated with a second CCF, where the one or more service APIs associated with the first CCF and the one or more service APIs associated with the second CCF correspond to respective CCF addresses or respective CCF IDs, and receive a response to the request that indicates one or more of the respective CCF addresses or the respective CCF IDs corresponding to the one or more service APIs associated with the first CCF and the one or more service APIs associated with the second CCF.

In some implementations of the method and apparatuses described herein, the device stores, at the API invoker, the respective CCF addresses or the respective CCF IDs corresponding to the one or more service APIs associated with the first CCF and the one or more service APIs associated with the second CCF. Additionally, or alternatively, the response to the request includes a profile associated with the API invoker, and where the profile indicates a method for the API invoker to authenticate and authorize one or more AEFs. Additionally, or alternatively, the one or more AEFs are associated with the second CCF, and where the response includes one or more of AEF information associated with the one or more AEFs, additional respective CCF addresses or additional respective CCF IDs corresponding to the one or more AEFs, respective security methods corresponding to the one or more AEFs, or additional respective security methods corresponding to the one or more service APIs associated with the second CCF. Additionally, or alternatively, the profile includes a certificate associated with the API invoker for subsequent authentication procedures with the first CCF and for establishing a connection with the one or more AEFs. Additionally, or alternatively, the response includes one or more of an ID assigned to the API invoker by the first CCF, additional respective CCF addresses or additional respective CCF IDs corresponding to one or more AEFs associated with at least one of the first CCF or the second CCF, a root certificate to validate one or more server certificates corresponding to the one or more AEFs, a certificate associated with the API invoker, and an onboard secret associated with the API invoker.

Some implementations of the method and apparatuses described herein may further include a device to implement a first CCF for wireless communication to receive, from an API invoker, first signaling requesting a security method associated with one or more AEFs for accessing one or more service APIs, where the first signaling includes one or more of respective CCF addresses corresponding to the one or more AEFs, respective CCF IDs corresponding to the one or more AEFs, or a uniform resource ID (URI) associated with the API invoker, transmit, to a second CCF, second signaling requesting respective security methods corresponding to at least a portion of AEFs of the one or more AEFs based on the respective CCF addresses indicating that the portion of the AEFs is associated with the second CCF, receive, from the second CCF, third signaling that indicates the respective security methods corresponding to the portion of the AEFs and respective security data sharing criterion corresponding to the portion of the AEFs, and transmit, to the API invoker, fourth signaling that indicates the respective security methods corresponding to the portion of the AEFs, the respective security data sharing criterion corresponding to the portion of the AEFs, and the respective CCF addresses or the respective CCF IDs corresponding to the portion of the AEFs.

In some implementations of the method and apparatuses described herein, the device obtains, based on a connection between the first CCF and the second CCF, the respective CCF addresses or the respective CCF IDs corresponding to the AEFs and additional respective CCF addresses or additional respective CCF IDs corresponding to the one or more service APIs, and stores, at the first CCF, one or more of the respective CCF addresses or the respective CCF IDs corresponding to the one or more AEFs, the additional respective CCF addresses or the additional respective CCF IDs corresponding to the one or more service APIs, service API information corresponding to the one or more service APIs, and AEF information corresponding to the one or more AEFs. Additionally, or alternatively, the device selects, based on security capability information associated with the API invoker, additional respective security methods corresponding to an additional portion of the one or more AEFs associated with the first CCF, where the first signaling indicates the security capability information associated with the API invoker, and where the fourth signaling indicates the additional respective security methods corresponding to the additional portion of the one or more AEFs, respective security data sharing criterion corresponding to the additional portion of the AEFs, and the respective CCF addresses or the respective CCF IDs corresponding to the additional portion of the AEFs.

Additionally, or alternatively, the device transmits, to the second CCF, fifth signaling that includes information, where the information includes at least one of an ID associated with the API invoker, the URI associated with the API invoker, security information to secure respective connections between the API invoker and the portion of the AEFs based on the respective security methods, and receives, from the second CCF, sixth signaling that indicates the second CCF successfully stores the information. Additionally, or alternatively, the second signaling includes an ID associated with the API invoker, an ID associated with the first CCF, an indication of at least a portion of service APIs associated with the second CCF of the one or more service APIs, one or more access scenarios, the respective CCF addresses or the respective CCF IDs corresponding to the portion of the AEFs, and one or more security methods. Additionally, or alternatively, the third signaling includes a validity time associated with a connection between the API invoker and the portion of the AEFs.

Some implementations of the method and apparatuses described herein may further include a device to implement a first CCF for wireless communication to receive, from a second CCF, first signaling requesting respective security methods associated with one or more AEFs for an API invoker to access one or more service APIs, where respective CCF addresses or respective CCF IDs corresponding to the one or more AEFs indicate that the one or more AEFs are associated with the first CCF, select, based on the second CCF being authorized to access the respective security methods, the respective security methods and respective security data sharing criterion corresponding to the AEFs, and transmit, to the second CCF, second signaling that indicates the respective security methods corresponding to the one or more AEFs and the respective security data sharing criterion corresponding to the AEFs.

In some implementations of the method and apparatuses described herein, the first signaling includes an ID associated with the API invoker, an ID associated with the second CCF, an indication that the one or more service APIs are associated with the first CCF, one or more access scenarios, the respective CCF addresses or the respective CCF IDs corresponding to the one or more AEFs, and one or more security methods, and where the respective security methods are selected from the one or more security methods based on one or more of the indication of one or more service APIs associated with the first CCF, the one or more access scenarios, or respective capabilities of the one or more AEFs. Additionally, or alternatively, the device receives, from the second CCF, third signaling that includes information, where the information includes at least one of an ID associated with the API invoker, a URI associated with the API invoker, security information to secure respective connections between the API invoker and the one or more AEFs based on the respective security methods, stores, at the first CCF, the information, and transmits, to the second CCF, fourth signaling that indicates the first CCF successfully stores the security information. Additionally, or alternatively, the second signaling includes one or more of a validity time associated with a connection between the API invoker and the one or more AEFs. Additionally, or alternatively, the respective security data sharing criterion corresponding to the AEFs includes security information related to the respective security methods.

### BRIEF DESCRIPTION OF THE DRAWINGS

FIG. 1 illustrates an example of a wireless communications system in accordance with aspects of the present disclosure.

FIGS. 2 and 3 illustrate examples of interconnected CCF network diagrams, in accordance with aspects of the present disclosure.

FIGS. 4 and 5 illustrate example signaling diagrams, in accordance with aspects of the present disclosure.

FIG. 6 illustrates an example of a UE in accordance with aspects of the present disclosure.

FIG. 7 illustrates an example of a processor in accordance with aspects of the present disclosure.

FIG. 8 illustrates an example of an NE in accordance with aspects of the present disclosure.

FIG. 9 illustrates a flowchart of a method performed by a device implementing a CCF in accordance with aspects of the present disclosure.

FIG. 10 illustrates a flowchart of a method performed by a device implementing an API invoker in accordance with aspects of the present disclosure.

FIG. 11 illustrates a flowchart of a method performed by a device implementing a first CCF in accordance with aspects of the present disclosure.

FIG. 12 illustrates a flowchart of a method performed by a device implementing a second CCF in accordance with aspects of the present disclosure.

### DETAILED DESCRIPTION

A wireless communications system may implement frameworks and functions for devices (e.g., UEs and NEs) to access one or more services and applications. For example, the wireless communications system may implement a CCF to handle API exposure, policy management, and analytics. The CCF may include data storage that maintains information about available APIs (e.g., service APIs) and may perform one or more different security methods to ensure secure and controlled access to network resources. In some examples, an API invoker may access service APIs via the CCF and an AEF through a multi-step process. Initially, the API invoker may register with a CCF to establish an identity and obtain credentials, which may be referred to as onboarding. This onboarding process may involve the API invoker providing authentication information and receiving a unique ID for future interactions. Once onboarded, the API invoker may identify available service APIs by querying the data storage of the CCF. After identifying the service APIs, the API invoker may request authorization from the CCF to access the service API. The authorization process may involve the CCF validating credentials of the API invoker and checking permissions against defined policies (e.g., according to a security method). Upon successful authorization, the CCF may issue an access token for the service API to the API invoker. The API invoker may then request access to the service API from the AEF using the access token according to the security method. The AEF may validate the access token with the CCF to ensure authenticity of the access token and verify the permissions of the API invoker. Once the AEF confirms the validity of the access token, the AEF may process the request and provide access to the requested service API.

The wireless communications system may implement multiple interconnected CCFs, where respective CCFs belong to different trust domains. A trust domain refers to a logical boundary or grouping within which a set of CCFs, AEFs, and other NEs operate under a common set of security policies, authentication mechanisms, and access control rules. An AEF belonging to a first CCF may select a security method to provide for authentication and authorization of an API invoker to the AEF. However, a second CCF may onboard the API invoker, such that the first CCF may not have sufficient information related to the API invoker (e.g., an ID of the API invoker). Thus, the AEF may fail to store the selected security method and security information. Additionally, or alternatively, an API invoker may not be able to determine whether an AEF belongs to the first CCF or the second CCF, which results in failure to transport security information from the first CCF to the second CCF, or vice-versa.

As described herein, a first CCF may obtain service API and/or AEF information for service APIs and/or AEFs offered by other CCFs interconnected with the first CCF along with respective CCF addresses (e.g., IDs) for the APIs and/or AEFs. For example, if the first CCF is interconnected with a second CCF, then the first CCF may obtain service API and/or AEF information with CCF addresses of the second CCF. An API invoker may send a request to the first CCF to access one or more service APIs (e.g., via AEFs) of the first CCF or another CCF interconnected with the first CCF. The first CCF may verify that the API invoker is authorized to access the service APIs and may transmit a response to the API invoker that includes respective CCF addresses of the requested service APIs. The API invoker may store the respective CCF addresses of the requested service APIs for future authentication and authorization between the API invoker and AEFs of the first CCF or the other CCFs.

In some examples, the first CCF may receive a request from an API invoker for one or more security methods for accessing one or more service APIs via one or more AEFs. The security request may include respective CCF addresses for one or more AEFs. If the service APIs are accessible via AEFs of the first CCF, then the first CCF may select the respective security methods for accessing the service APIs. Additionally, or alternatively, if the service APIs are accessible via AEFs of a second CCF, then the first CCF may transmit a request to the second CCF for the respective security methods for accessing the service APIs. The second CCF may select the respective security methods for accessing the service APIs and may transmit the respective security methods in a response to the first CCF. The first CCF may forward the respective security methods (e.g., for accessing the service APIs via AEFs of the first CCF and for accessing the service APIs via AEFs of the second CCF) to the API invoker. The API invoker may store the selected security methods, which may be for respective AEFs, along with designated CCF addresses.

Reference is made herein to communicating data or information, such as signaling information in an onboarding procedure or a security method selection procedure and/or communications that are transmitted or received between devices or functions in a network. It is to be appreciated that other terms may be used interchangeably with communicating, such as signaling, transmitting, receiving, outputting, forwarding, retrieving, obtaining, and so forth.

Aspects of the present disclosure are described in the context of a wireless communications system.

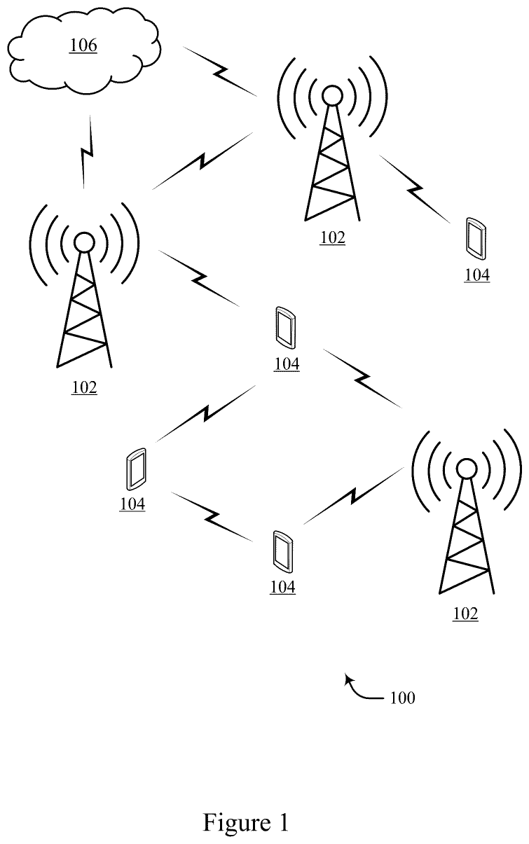

FIG. 1 illustrates an example of a wireless communications system 100 in accordance with aspects of the present disclosure. The wireless communications system 100 may include one or more NEs 102, one or more UEs 104, and a core network (CN) 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a new radio (NR) network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NEs 102 may be dispersed throughout a geographic region to form the wireless communications system 100. One or more of the NEs 102 described herein may be or include or may be referred to as a network node, a base station, a network element, a network function, a network entity, a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NE 102.

The one or more UEs 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N6, or other network interface). In some implementations, the NE 102 may communicate with each other directly. In some other implementations, the NE 102 may communicate with each other indirectly (e.g., via the CN 106). In some implementations, one or more NEs 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a packet data network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NEs 102 associated with the CN 106.

The CN 106 may communicate with a packet data network over one or more backhaul links (e.g., via an S1, N2, N6, or other network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHz), FR2 (24.25 GHz-52.6 GHz), FR3 (7.125 GHz-24.25 GHz), FR4 (52.6 GHz-114.25 GHz), FR4a or FR4-1 (52.6 GHz-71 GHz), and FR5 (114.25 GHz-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

In some examples, a device in the wireless communications system 100 (e.g., an NE 102 and/or a UE 104) may implement one or more frameworks and/or functions to access APIs. An API, such as a service API, may refer to a set of protocols, routines, and tools that enable software applications to interact with and access network services or functionalities provided by the wireless communications system 100. Service APIs may define methods, data structures, and communication protocols that provide for API invokers to request and utilize various network capabilities or resources. Service APIs may include interfaces for accessing network functions, such as location services, quality of service management, device capabilities, network slicing, or data analytics. For example, a location service API may provide for an application to request real-time location information of a UE 104. A quality of service API may enable an application to request network performance parameters for a data transmission. A device capabilities API may provide information about hardware and software features of a UE 104. A network slicing API may provide for requesting and configuring virtual network resources tailored to application criterion (e.g., requirements). A data analytics API may offer access to aggregated network statistics and user behavior insights. One or more APIs may be exposed by AEFs and managed by CCFs for secure and controlled access to network resources. API invokers, such as third-party applications or network functions, may discover, authenticate, and utilize the APIs to enhance functionality of the API invokers and to integrate with the wireless network infrastructure.

In some cases, exposing an API refers to the process of making a set of functions, protocols, or tools available for external applications or services to interact with and utilize. For example, AEFs may expose APIs by providing an interface through which API invokers access network services or functionalities. AEFs may expose various types of APIs corresponding to different network capabilities. A location AEF may expose a location API that provides for authorized applications to request and receive location information of UEs 104 (e.g., to query real-time location, set up geofencing alerts, or access historical location data). A quality of service (QoS) AEF may expose APIs that enable applications to request and manage network performance parameters (e.g., to request bandwidth allocations, set latency criterion, or modify QoS settings dynamically). A device capabilities AEF may expose APIs that provide information about UE features and capabilities (e.g., to query device hardware specifications, check supported network technologies, or retrieve information about installed software and applications). A network slicing AEF may expose APIs that provide for the creation, modification, and management of virtual network slices (e.g., to request a new network slice with performance characteristics, modify existing network slice parameters, or terminate access to a network slice). The AEF manages the exposure of APIs by configuring access control, processing requests, and interfacing with backend services and databases to fulfill API calls from authorized API invokers.

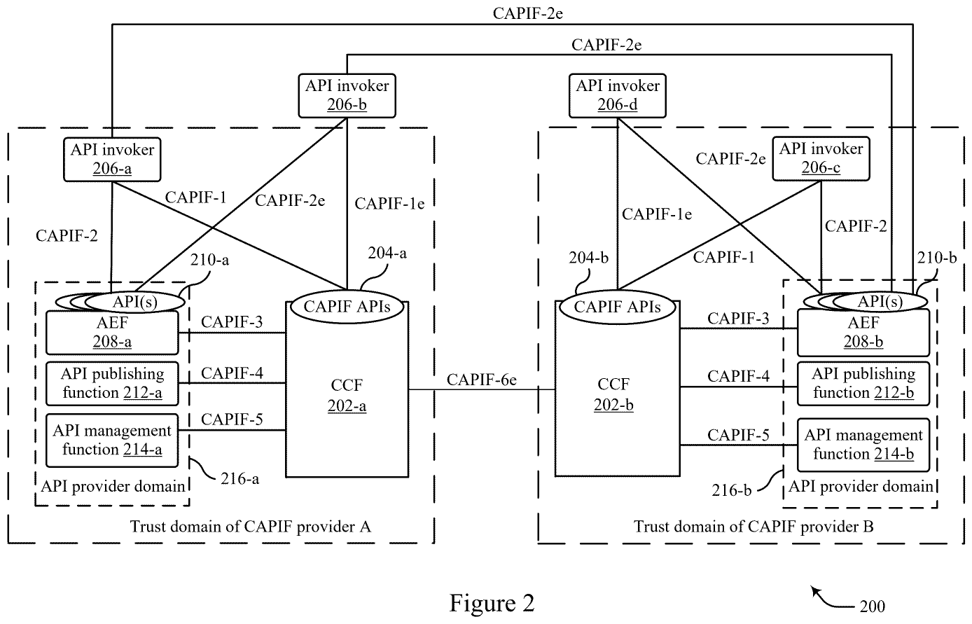

An NE 102 and/or a UE 104 may implement a CCF, an AEF, an API invoker, or other functions and/or components for a CAPIF, as described in further detail with respect to FIG. 2, through various hardware and software configurations. For example, an NE 102 may implement a CCF using a combination of processors, memory, and network interfaces. The processors may execute software instructions stored in the memory to perform CAPIF functions, such as API exposure, policy management, and analytics. The network interfaces may enable communication with other network elements, AEFs, and API invokers. An NE 102 and/or a UE 104 may implement an AEF as software to handle exposure of APIs, process API requests, and interact with one or more CCFs for authentication and authorization. The AEF software may include interfaces to backend services and databases that the exposed APIs access. A UE 104 and/or an NE 102 may implement an API invoker through a software application or framework for discovering available APIs, handling authentication and authorization with CCFs, and making API calls to AEFs. The API invoker may store credentials, tokens, and other security information in secure storage at the UE 104 and/or the NE 102.

According to implementations, one or more of the NEs 102 and the UEs 104 are operable to implement various aspects of the techniques described with reference to the present disclosure. For example, a UE 104 and/or an NE 102 may implement one or more CCFs, including a first CCF and one or more other CCFs, including a second CCF. The first CCF may obtain API and/or AEF information for APIs and/or AEFs offered by other CCFs interconnected with the first CCF along with respective CCF addresses (e.g., IDs) for the APIs and/or AEFs. For example, if the first CCF is interconnected with a second CCF, then the first CCF may obtain API and/or AEF information with CCF addresses of the second CCF. An API invoker may send a request to the first CCF to access one or more APIs (e.g., via AEFs) of the first CCF or another CCF interconnected with the first CCF. The first CCF may verify that the API invoker is authorized to access the APIs and may transmit a response to the API invoker that includes respective CCF addresses of the requested APIs. The API invoker may store the respective CCF addresses of the requested APIs for future authentication and authorization between the API invoker and AEFs of the first CCF or the other CCFs.

In some examples, the first CCF may receive a request from an API invoker for one or more security methods for accessing one or more APIs via one or more AEFs. The security request may include respective CCF addresses for one or more AEFs. If the APIs are accessible via AEFs of the first CCF, then the first CCF may select the respective security methods for accessing the APIs. Additionally, or alternatively, if the APIs are accessible via AEFs of a second CCF, then the first CCF may transmit a request to the second CCF for the respective security methods for accessing the APIs. The second CCF may select the respective security methods for accessing the APIs and may transmit the respective security methods in a response to the first CCF. The first CCF may forward the respective security methods (e.g., for accessing the APIs via AEFs of the first CCF and for accessing the APIs via AEFs of the second CCF) to the API invoker. The API invoker may store the selected security methods, which may be for respective AEFs, along with designated CCF addresses.

FIG. 2 illustrates an example interconnected CCF network diagram 200 in accordance with aspects of the present disclosure. In some examples, the interconnected CCF network diagram 200 implements or is implemented by aspects of the wireless communications system 100. For example, the interconnected CCF network diagram 200 may be implemented by one or more NEs and/or one or more UEs, which may be examples of the corresponding devices as described with reference to FIG. 1. The NEs and/or UEs may be examples of devices that implement one or more CCFs, API invokers, and AEFs, as described with reference to FIG. 1.

In some cases, a single device may implement a CCF 202-a and a CCF 202-b. In some other examples, a device may implement the CCF 202-a, and a different device may implement the CCF 202-b. The CCF 202-a may be interconnected with the CCF 202-b via an interface, referred to as a CAPIF-6e interface. The CCF 202-a and the CCF 202-b may exchange control information and/or data via the CAPIF-6e interface. The CAPIF-6e interface may be an example of a wired or wireless connection. Example wired connections include, but are not limited to, ethernet connections, fiber optic links, or serial interfaces. For example, an NE implementing a CCF may use a fiber optic connection to communicate with other CN functions or data centers. Wireless interfaces may include over the air interfaces, such as cellular interfaces (e.g., NR), Wi-Fi, Bluetooth, or satellite communications. For example, a UE implementing an API invoker may use a transmitter or receiver to establish a wireless connection with an NE and communicate with CCFs and AEFs implemented by the NE. NEs may employ wireless backhaul links using over the air interfaces to connect remote sites to the CN.

The CCF 202-a may implement one or more CAPIF APIs 204-a, and a CCF 202-b may implement one or more CAPIF APIs 204-b. The CAPIF APIs 204-a and/or the CAPIF APIs 204-b may include a set of interfaces and functions provided by the CCF 202-a and the CCF 202-b, respectively, that enable interaction with and management of the CAPIF system. The CAPIF APIs 204-a and/or the CAPIF APIs 204-b may provide for other NEs, API invokers, and administrators to interact with the CCF 202-a and the CCF 202-b for API discovery, onboarding, security, and management, among other procedures. The CAPIF APIs 204-a and/or the CAPIF APIs 204-b may include interfaces for API invoker onboarding, which provides for new API consumers to register with the CCF 202-a and the CCF 202-b and obtain credentials. The CAPIF APIs 204-a and/or the CAPIF APIs 204-b may also provide functions for API discovery, enabling API invokers to search for and retrieve information about available APIs across interconnected CCFs.

For example, the CCF 202-a may establish a connection with one or more API invokers, such as the API invoker 206-a and the API invoker 206-b via the CAPIF API 204-a. The CCF 202-b may establish a connection with one or more API invokers, such as the API invoker 206-c and the API invoker 206-d. The connection between the CAPIF APIs 204-a and the API invoker 206-a, as well as the CAPIF APIs 204-b and the API invoker 206-c may be an example of a CAPIF-1 connection, which may be an example of a wired or wireless connection. The CAPIF-1 connection may be between CAPIF APIs and API invokers within a same trust domain of a CAPIF provider. For example, the CCF 202-a (e.g., and the CAPIF APIs 204-a) and the API invoker 206-a may be within the trust domain of a CAPIF provider A. The CCF 202-b (e.g., and the CAPIF APIs 204-b) and the API invoker 206-c may be within the trust domain of a CAPIF provider B. A trust domain of a CAPIF provider may refer to a logical boundary or grouping within which a set of CCFs, AEFs, and other network elements operate under a common set of security policies, authentication mechanisms, and access control rules. The trust domain may establish a framework of trust relationships between various components and entities within the CAPIF system.

The connection between the CAPIF APIs 204-a and the API invoker 206-b, as well as the CAPIF APIs 204-b and the API invoker 206-d may be an example of a CAPIF-1e connection, which may be an example or a wired or wireless connection. The CAPIF-1e connection may be between CAPIF APIs and API invokers that are outside of a trust domain of a CAPIF provider of the CAPIF APIs. For example, the API invoker 206-b may be outside of the trust domain of a CAPIF provider A of the CCF 202-a (e.g., and the CAPIF APIs 204-a). The API invoker 206-d may be outside of the trust domain of a CAPIF provider B of the CCF 202-b (e.g., and the CAPIF APIs 204-b). The CCF 202-a may establish a connection, such as a CAPIF-3 connection, with an AEF 208-a that exposes one or more APIs 210-a. The CCF 202-a may establish a connection, such as a CAPIF-4 connection, with an API publishing function 212-a. An API publishing function may refer to a component or service within an API provider that handles tasks related to registering, cataloging, and managing the lifecycle of APIs exposed by various AEFs. The API publishing function may ensure that published APIs align with CAPIF policies and security criterion. The CCF 202-a may establish a connection, such as a CAPIF-5 connection, with an API management function 214-a. An API management function may facilitate the creation, publication, maintenance, and monitoring of APIs. This function may provide capabilities for API design, testing, deployment, versioning, security, analytics, and developer support.

The CCF 202-b may establish a connection, such as a CAPIF-3 connection, with an AEF 208-b that exposes one or more APIs 210-b. The CCF 202-b may establish a connection, such as a CAPIF-4 connection, with an API publishing function 212-b. The CCF 202-b may establish a connection, such as a CAPIF-5 connection, with an API management function 214-b. The API invoker 206-a through the API invoker 206-d may establish a connection with the APIs 210-b and the APIs 210-a, such as a CAPIF-2 connection for API invokers within a trust domain of a CAPIF provider of the APIs or a CAPIF-2e connection for API invokers outside of the trust domain of the CAPIF provider of the APIs. A CAPIF-2 connection, a CAPIF-2e connection, a CAPIF-3 connection, a CAPIF-4 connection, and a CAPIF-5 connection may be examples of wired or wireless connections.

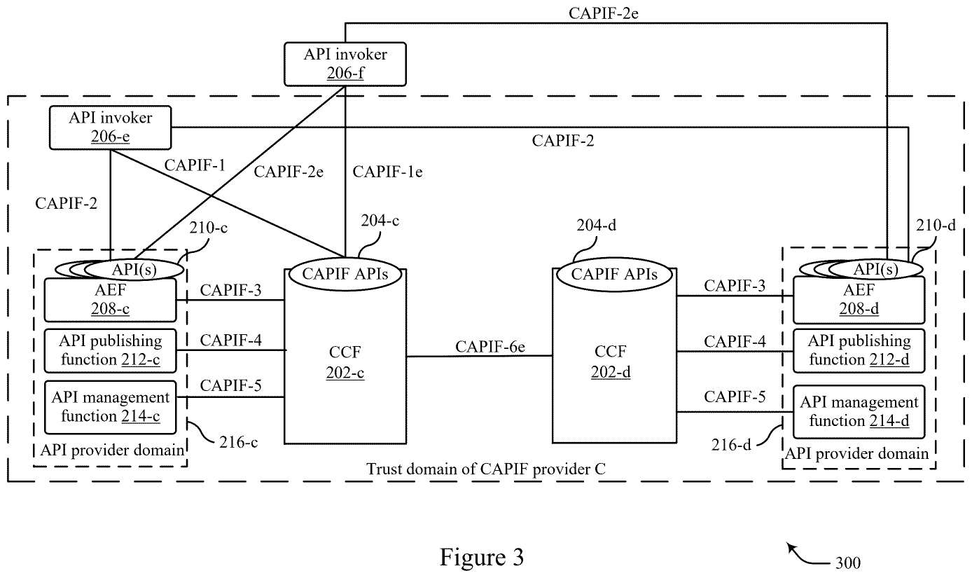

In some examples, the interconnection between the CCF 202-a and the CCF 202-b provides for API invokers of a CAPIF provider to utilize the APIs (e.g., service APIs) from third-party CAPIF providers, where the CAPIF providers belongs to different trust domains. Additionally, or alternatively, the interconnection between CCFs may be within a same CAPIF provider trust domain, which is described in further detail with respect to FIG. 3. The CCFs being within a same CAPIF provider trust domain provides for API invokers of a first CCF to utilize the APIs from a second CCF, where both the first CCF and the second CCF are hosted within the trust domain of the CAPIF provider.

In some examples, a CCF (e.g., one of the CCF 202-a and the CCF 202-b) may be a designated CCF, which is a CCF configured as a serving CCF for interconnection. Multiple organizations with a relationship that have deployed a CAPIF may interoperate to provide for API invokers in respective trust domains to utilize service APIs from both CAPIFs. The CAPIF provider A and the CAPIF provider B host the CAPIF in respective trust domains (e.g., a business relationship may exist between the CAPIF providers). The CAPIF providers in the respective trust domains may host multiple CAPIF instances, where each CAPIF instance includes a local CCF, the API provider domain, and the API invokers. When multiple CAPIF instances are deployed by a CAPIF provider there may be a hierarchy associated with the multiple CCFs deployed. A designated CCF of the CAPIF provider A (e.g., the CCF 202-a) may interconnect with a designated CCF of the CAPIF provider B (e.g., the CCF 202-b). Within CAPIF provider A, one or more CCFs interact with the designated CCF. The designated CCF of the CAPIF provider A provides information about the CAPIF instances and APIs deployed by the CAPIF provider A to the designated CCF of the CAPIF provider B (e.g., the CCF 202-b) and vice-versa via the CAPIF-6e connection.

The CCF 202-a of CAPIF provider A provides the information about the APIs to the CCF 202-b over CAPIF-6 reference point. The API invokers may exist within the trust domain of CAPIF provider A, within the trust domain of CAPIF provider B, or outside of the trust domains of both the CAPIF provider A and the CAPIF provider B. The API invoker of a CAPIF provider is onboarded with the CCF in the corresponding trust domain of the CAPIF provider. One or more CCFs can publish APIs to the designated CCF over the CAPIF-6 connection and discover the APIs from the designated CCF and vice versa over the CAPIF-6 connection. The API invoker within the trust domain of the CAPIF provider A interacts with the CCF of the CAPIF provider A via CAPIF-1 and discovers the APIs of both CAPIF providers and invokes the service APIs in the trust domain of CAPIF provider A via CAPIF-2 and invokes the service APIs in the trust domain of CAPIF provider B via CAPIF-2e. The API invoker from outside the trust domain of CAPIF providers, interacts with the CCF of the CAPIF provider A via CAPIF-1e and invokes the service APIs in the trust domain of the CAPIF providers via CAPIF-2e. In some cases, the communication between the CCF of the CAPIF providers over CAPIF-6 or CAPIF-6e can be API based.

In some examples, the APIs 210-a, the AEF 208-a, the API publishing function 212-a, and the API management function 214-a may be part of an API provider domain 216-a. The APIs 210-b, the AEF 208-b, the API publishing function 212-b, and the API management function 214-b may be part of an API provider domain 216-b. An API provider domain defines infrastructure, processes, and policies for the creation, deployment, and maintenance of APIs within the API provider domain, as well as the management of associated resources and access controls.

FIG. 3 illustrates an example interconnected CCF network diagram 300 in accordance with aspects of the present disclosure. In some examples, the interconnected CCF network diagram 300 implements or is implemented by aspects of the wireless communications system 100 and the example interconnected CCF network diagram 200. For example, the interconnected CCF network diagram 300 may be implemented by one or more NEs and/or one or more UEs, which may be examples of the corresponding devices as described with reference to FIG. 1. The NEs and/or UEs may be examples of devices that implement one or more CCFs, API invokers, and AEFs, as described with reference to FIGS. 1 and 2.

In some examples, the example interconnected CCF network diagram 300 includes an API invoker 206-e within a trust domain of a CAPIF provider C and an API invoker 206-f outside of the trust domain of the CAPIF provider C. The example interconnected CCF network diagram 300 may also include a CCF 202-c with one or more CAPIF APIs 204-c and a CCF 202-d with one or more CAPIF APIs 204-d, which may be interconnected CCFs (e.g., via the CAPIF-6e connection). The CCF interconnection within the same CAPIF provider domain provides for API invokers of CCF 202-c (e.g., the API invoker 206-e and/or the API invoker 206-f) to utilize the APIs 210-d from a CCF 202-d, where both the CCF 202-c and the CCF 202-d are hosted within the trust domain of the CAPIF provider C. The CCF 202-c may be connected to the APIs 210-c, the AEF 208-c, the API publishing function 212-c, and the API management function 214-c (e.g., via a CAPIF-3 connection, a CAPIF-4 connection, and a CAPIF-5 connection). The CCF 202-d may be connected to the APIs 210-d, the AEF 208-d, the API publishing function 212-d, and the API management function 214-d (e.g., via a CAPIF-3 connection, a CAPIF-4 connection, and a CAPIF-5 connection). The API invoker 206-f may be connected to the APIs 210-c and the APIs 210-d via a CAPIF-2e connection. The API invoker 206-e may be connected to the APIs 210-c and the APIs 210-d via a CAPIF-2 connection. In some examples, the APIs 210-c, the AEF 208-c, the API publishing function 212-c, and the API management function 214-c may be part of an API provider domain 216-c. The APIs 210-d, the AEF 208-d, the API publishing function 212-d, and the API management function 214-d may be part of an API provider domain 216-d.

In some examples, one or more API invokers (e.g., residing at an application function (AF), client device, or UE) are onboarded to the CCF of a CAPIF provider. The API invokers access APIs (e.g., service APIs) exposed by an AEF of the same CAPIF provider or CCF using a CAPIF-2 or CAPIF-2e interface. For interconnected CCFs, there may be a relationship and/or service level agreements (SLAs) between different CCFs and/or CAPIF providers (e.g., the CAPIF provider A and B, as described with reference to FIG. 2). An API invoker may be onboarded to a CCF of a CAPIF provider A and access APIs exposed by the AEFs of other CCFs of a same CAPIF provider A or a different CAPIF provider B using the CAPIF-2 or the CAPIF-2e interface. Following successful onboarding of an API invoker to a CCF (e.g., a designated CCF in a CAPIF provider domain, CCF 202-c), one or more security methods to be used to secure the CAPIF-2 or the CAPIF-2e interface between the API Invoker and an AEF belonging to another CCF (e.g., CCF 202-d) are selected. Security information (e.g., a public private key pair or a client certificate of the API invoker, a root certificate to validate the client certificate, a secret key, a pre-shared secret key (PSK), a CCF certificate or a public key to validate an OAuth access token) is stored at the CCF (e.g., the CCF 202-c) and fetched by the AEF of the other CCF (e.g., the CCF 202-d) to perform CAPIF-2 or CAPIF-2e related authentication and authorization for the API invoker service API invocation.

Since the AEF belongs to the CCF 202-d, the CCF 202-d may select the security method. As the API invoker is onboarded to the CCF 202-c, the CCF 202-d may not be aware of the information related to the API invoker (e.g., API invoker ID). Thus, storage of the selected security method and security information sharing to the AEF may not be successful. Additionally, or alternatively, an API invoker may be unable to determine whether an AEF belongs to the CCF 202-c or the CCF 202-d, which may impact security information provisioning or transfer from the CCF 202-c to the CCF 202-d. For example, the CCF 202-d may not have sufficient information about an API invoker to select and store or manage security methods and security information for the API invoker to enable CAPIF-2 or CAPIF-2e authentication. In some other examples, an API invoker may be unable to determine whether one or more AEFs are related to different CCFs (e.g., the CCF 202-c or the CCF 202-d), and therefore the API invoker may not have sufficient information to send to a designated CCF (e.g., the CCF 202-c) upon authentication for accessing APIs via the AEFs.

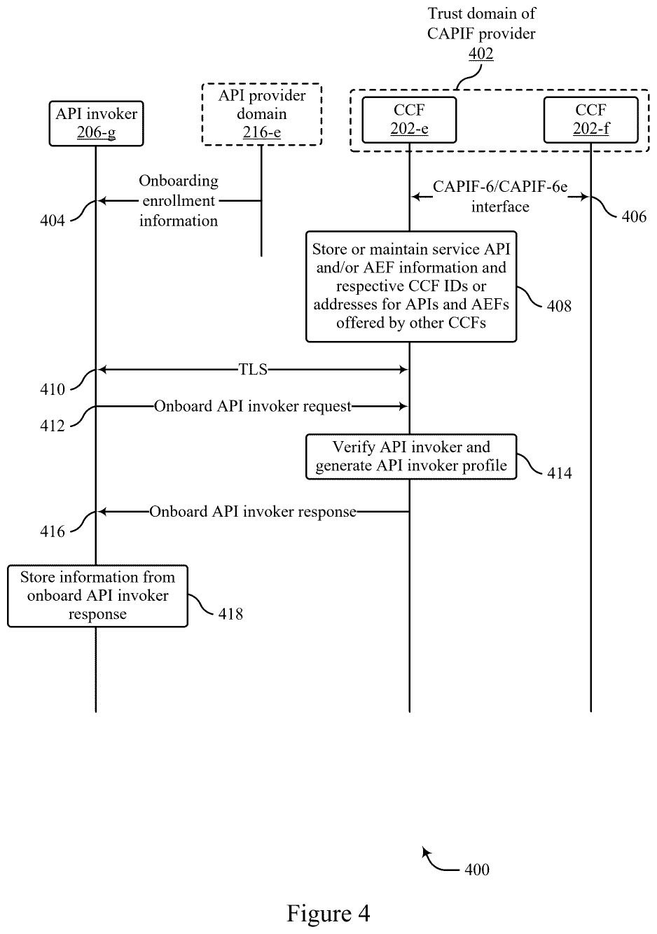

FIG. 4 illustrates a signaling diagram 400 in accordance with aspects of the present disclosure. In some examples, the signaling diagram 400 implements or is implemented by aspects of the wireless communications system 100, the interconnected CCF network diagram 200, and the interconnected CCF network diagram 300. The signaling diagram 400 may implement or be implemented by one or more devices (e.g., UEs and/or NEs) implementing an API invoker 206-g, an API provider domain 216-e, a CCF 202-e, and a CCF 202-f, which may be examples of the corresponding devices, components, and functions as described with reference to FIGS. 1 through 3. For example, an API invoker 206-g may onboard to the CCF 202-e, which may be a designated CCF, to access one or more service APIs of the CCF 202-e and/or the CCF 202-f. The CCF 202-e and the CCF 202-f may be interconnected. Alternative examples of the following may be implemented, where some processes are performed in a different order than described or are not performed. In some cases, processes may include additional features not mentioned below, or further processes may be added.

In some examples, the CCF 202-e and the CCF 202-f may be within a same trust domain of a CAPIF provider 402, as described with reference to FIG. 3. In some other examples, the CCF 202-e and the CCF 202-f may be within different trust domains of different CAPIF providers, as described with reference to FIG. 2.

In some examples, the API invoker 206-g may perform an onboarding procedure with the CCF 202-e, which may be a designated CCF. The onboarding procedure may provision the API invoker 206-g with CCF information (e.g., ID and/or address) for respective AEFs to enable the API invoker 206-g to initiate CAPIF interconnection related procedures. For example, the API invoker 206-g onboarded to the CCF 202-e may perform security information fetching or provisioning for an AEF connected to the CCF 202-f for CAPIF-2 and/or CAPIF-2e authentication and authorization.

The API invoker 206-g and the CCF 202-e may secure and authenticate onboarding of the API invoker 206-g to the CCF 202-e. For example, at 404, prior to the onboarding procedure, the API invoker 206-g obtains onboarding enrolment information from the API provider domain 216-e. The API invoker 206-g uses the onboarding enrolment information to authenticate and establish a secure transport layer security (TLS) communication with the CCF 202-e during the onboarding process. The enrolment information includes details of the CCF 202-e (e.g., address, and root certificate authority (CA) certificate) and includes an onboarding credential (e.g., an OAuth 2.0 access token).

In some cases, two organizations with a relationship (e.g., a business relationship) that have each deployed CAPIF may interoperate to provide for API invokers in each trust domain to utilize APIs, such as service APIs, from both CAPIFs. From the perspective of each CAPIF provider the other CAPIF provider is a third-party. The designated CCF of a CAPIF provider A provides the information about the CAPIF instances and APIs deployed by the CAPIF provider A to the designated CCF of the CAPIF provider B, and vice-versa over a CAPIF-6e interface (e.g., reference point). Additionally, or alternatively, the designated CCF of the CAPIF provider A provides the information about the APIs to another CCF over a CAPIF-6 interface or reference point, where the CCFs belongs to a same CAPIF provider A. For example, the CCF 202-e may be the designated CCF of a CAPIF provider with the CCF 202-e and a CCF 202-f that are both within a trust domain of the CAPIF provider 402. An API invoker may be within the trust domain of a CAPIF provider A, within a trust domain of a CAPIF provider B, or outside of the trust domains of both the CAPIF provider A and the CAPIF provider B. The API invoker of a CAPIF provider is onboarding with the CCF in the corresponding trust domain of the CAPIF provider. For example, the API invoker 206-g of a CAPIF provider is onboarding with the CCF 202-e.

At 406, the CCF 202-e may establish a CAPIF-6 or CAPIF-6e connection with the CCF 202-f. For example, if the CCF 202-e and the CCF 202-f are within a trust domain of the CAPIF provider 402, then the CCF 202-e and the CCF 202-f establish a CAPIF-6 connection. If the CCF 202-e and the CCF 202-f are in trust domains of different CAPIF providers, then the CCF 202-e and the CCF 202-f establish a CAPIF-6e connection.

The CCF 202-e may obtain (e.g., receive) an indication that the CCF 202-f supports, implements, or otherwise manages one or more service APIs. The CCF 202-f may transmit API (e.g., service API) and/or AEF information to the CCF 202-e via the established CAPIF-6 or CAPIF-6e connection. At 408, the CCF 202-e may store or maintain the API and/or AEF information, as well as respective CCF IDs and/or addresses for the APIs and/or AEFs offered by other CCFs, including the CCF 202-f. For example, the CCF 202-e may be a designated CCF in a trust domain of a CAPIF provider 402 and may store or maintain service API and/or AEF information and respective CCF IDs or address for APIs and AEFs offered by other designated or third-party CCFs.

At 410, the API invoker 206-g and the CCF 202-e may establish a secure TLS communication session (e.g., server side certificate authentication). For example, the API invoker 206-g may use the enrolment information obtained at 404 to establish the TLS session with the CCF 202-e. To establish the secure TLS communication, the API invoker 206-g and the CCF 202-e may perform a TLS procedure. The API invoker 206-g may initiate the connection with the CCF 202-e by sending an initial message to the CCF 202-e that requests a certificate. The CCF 202-e may send a certificate to the API invoker 206-g for authentication. The API invoker 206-g may verify the certificate against a trusted CA.

At 412, with a secure session established, the API invoker 206-g transmits an onboard API invoker request message to the CCF 202-e. The onboard API invoker request message may request access to service APIs of the CCF 202-e and/or service APIs of the CCF 202-f. The onboard API invoker request message carries an onboard credential obtained during pre-provisioning of the onboard enrolment information (e.g., an OAuth 2.0 access token). When the OAuth 2.0 token-based mechanism is used as the onboarding credential, the access token may be encoded as a JavaScript object notation (JSON) web token. A JSON web token may include a JSON web signature and may be validated per OAuth 2.0. Other credentials may also be used (e.g., message digest). The API invoker 206-g may generate a key pair {private key, public key} and provide the public key along with the onboard API invoker request message.

At 414, the CCF 202-e may verify the API invoker 206-g and generate an API invoker profile for the API invoker 206-g. The profile indicates a method for the API invoker 206-g to use to authenticate and authorize one or more AEFs. Additionally, or alternatively, the profile includes a certificate assigned to the API invoker 206-g for subsequent authentication procedures with the CCF 202-e and for establishing a connection with the AEFs. The AEFs may be implemented by the CCF 202-f and/or the CCF 202-e.

The CCF 202-e may validate the enrolment credentials of the API invoker 206-g (e.g., OAuth 2.0 access token). If validation of the credentials (e.g., the OAuth 2.0 access token) is successful, then the CCF 202-e may generate a profile for the API invoker 206-g, which may include the selected method for AEF authentication and authorization between the API invoker 206-g and an AEF. If the AEF or API belongs to CCF 202-f (e.g., another designated or third-party CCF), then the CCF 202-e may include AEF details or service API information stored at 408, along with CCF addresses or IDs for the CCF 202-f and security methods selected by the CCF 202-f for each AEF or API for AEF authentication and authorization by the CCF 202-f between the API invoker 206-g and the CCF 202-f. The CCF 202-e may generate a certificate for the API invoker 206-g using an identity (e.g., ID) assigned to the API invoker 206-g and a public key. The API invoker 206-g may use the certificate for subsequent authentication procedures with the CCF 202-e and for establishing a secure connection and authentication with AEFs of the CCF 202-e and/or the CCF 202-f.

The CCF 202-e may optionally generate an onboard_secret if the subscribed service API uses TLS with OAuth access token for CAPIF-2e security. The onboard_secret value remains the same during the lifetime of the onboarding, and may be bound to the CCF 202-e specific API invoker ID. When a third-party issues a client certificate for the API invoker 206-g, then at 412, the API invoker 206-g can additionally include the certificate in the onboard API invoker request message. If the CCF 202-e trusts the issuer of the client certificate of the API invoker 206-g, then the CCF 202-e includes the provided certificate in the profile of the API invoker 206-g at 414. The CAPIF domain policy may determine whether to accept the client certificates issued by the third-party.

At 416, the CCF 202-e may respond to the API invoker 206-g with an onboard API invoker response message. The response message may include the CCF 202-e assigned API invoker ID, AEF authentication and authorization information (e.g., if generated at 414) that includes the third-party or CCF 202-f ID or address per service API and/or AEF if the service API and/or AEF belongs to the CCF 202-f, a root certificate to validate the AEFs server certificate that belongs to the CCF 202-f (e.g., if available at 408 for CAPIF interconnection), a certificate of the API invoker 206-g, and the onboard_secret of the API invoker 206-g (e.g., if generated by the CCF 202-e).

At 418, the API invoker 206-g stores the information provided in the onboard API invoker response. For example, the API invoker 206-g stores the third-party or designated CCF IDs per service API and/or AEF, the related root certificate for the AEF server certificate validation, the API invoker 206-g ID, and/or the profile of the API invoker 206-g for further CAPIF-2 and/or CAPIF-2e authentication and authorization between the API invoker 206-g and the AEFs of the CCF 202-e or the CCF 202-f, respectively.

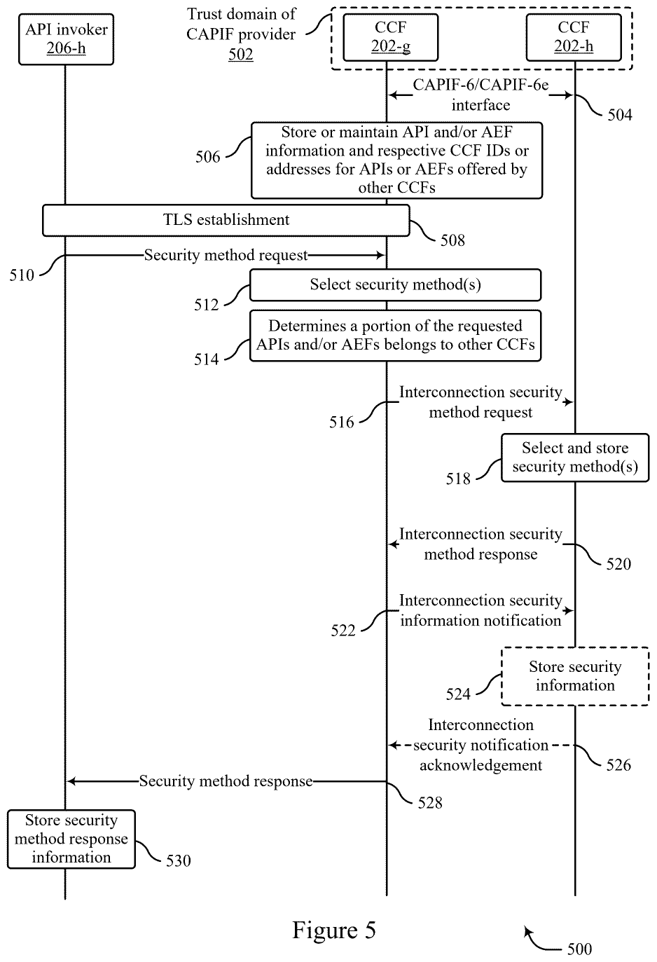

FIG. 5 illustrates a signaling diagram 500 in accordance with aspects of the present disclosure. In some examples, the signaling diagram 500 implements or is implemented by aspects of the wireless communications system 100, the interconnected CCF network diagram 200, the interconnected CCF network diagram 300, and the signaling diagram 400. The signaling diagram 500 may implement or be implemented by one or more devices (e.g., UEs and/or NEs) implementing an API invoker 206-h, a CCF 202-g, and a CCF 202-h, which may be examples of the corresponding devices, components, and functions as described with reference to FIGS. 1 through 4. For example, an API invoker 206-h may obtain security methods from the CCF 202-g, which may be a designated CCF, to access one or more service APIs of the CCF 202-g and/or the CCF 202-h. The CCF 202-g and the CCF 202-h may be interconnected. Alternative examples of the following may be implemented, where some processes are performed in a different order than described or are not performed. In some cases, processes may include additional features not mentioned below, or further processes may be added.

In some examples, the CCF 202-g and the CCF 202-h may be within a same trust domain of a CAPIF provider 502, as described with reference to FIG. 3. In some other examples, the CCF 202-g and the CCF 202-h may be within different trust domains of different CAPIF providers, as described with reference to FIG. 2.

The API invoker 206-h and the CCF 202-g may perform a security method negotiation procedure to enable security method selection for the API invoker 206-h with an API invoker ID by the CCFs involved in the CAPIF interconnection (e.g., the CCF 202-g and the CCF 202-h). The security method negotiation procedure may additionally, or alternatively, enable security information sharing (e.g., from the CCF 202-g to the CCF 202-h). The security method negotiation procedure may additionally, or alternatively, enable API invoker ID related security information storage at the CCF 202-h that provides the service APIs (e.g., via a connected AEF) belonging to a different CAPIF-B to the API invoker 206-h registered to the CCF 202-g in the CAPIF-A.

In some cases, two organizations with a relationship (e.g., a business relationship) that have each deployed CAPIF may interoperate to provide for API invokers in each trust domain to utilize APIs, such as service APIs, from both CAPIFs. From the perspective of each CAPIF provider the other CAPIF provider is a third-party. The designated CCF of a CAPIF provider A provides the information about the CAPIF instances and APIs deployed by the CAPIF provider A to the designated CCF of the CAPIF provider B, and vice-versa over a CAPIF-6e interface (e.g., reference point). Additionally, or alternatively, the designated CCF of the CAPIF provider A provides the information about the APIs to another CCF over a CAPIF-6 interface or reference point, where the CCFs belongs to a same CAPIF provider A. For example, the CCF 202-g may be the designated CCF of a CAPIF provider with the CCF 202-g and a CCF 202-h that are both within a trust domain of the CAPIF provider 502. An API invoker may be within the trust domain of a CAPIF provider A, within a trust domain of a CAPIF provider B, or outside of the trust domains of both the CAPIF provider A and the CAPIF provider B. The API invoker of a CAPIF provider is onboarding with the CCF in the corresponding trust domain of the CAPIF provider. For example, the API invoker 206-h of a CAPIF provider is onboarded with the CCF 202-g.

At 504, the CCF 202-g may establish a CAPIF-6 or CAPIF-6e connection with the CCF 202-h. For example, if the CCF 202-g and the CCF 202-h are within a trust domain of the CAPIF provider 502, then the CCF 202-g and the CCF 202-h establish a CAPIF-6 connection. If the CCF 202-g and the CCF 202-h are in trust domains of different CAPIF providers, then the CCF 202-g and the CCF 202-h establish a CAPIF-6e connection.

At 506, the CCF 202-g may store or maintain API (e.g., service API) and/or AEF information, as well as respective CCF IDs and/or addresses for the APIs and/or AEFs offered by other CCFs, including the CCF 202-h. For example, the CCF 202-g may be a designated CCF in a trust domain of a CAPIF provider 502 and may store or maintain service API and/or AEF information and respective CCF IDs or address for APIs and AEFs offered by other designated or third-party CCFs.

In some cases, an API invoker 206-h and a CCF 202-g may use a CAPIF-1 or a CAPIF-1e interface to exchange information (e.g., messages, signaling). For a CAPIF-1 interface, TLS is used to provide integrity protection, replay protection and confidentiality protection. The support of TLS is optional to use based on a policy of a domain administrator to protect interfaces within the trusted domain. For a CAPIF-1 interface, mutual authentication is based on client and server certificates between the CCF 202-g and the API invoker 206-h using TLS. Certificate based authentication uses one or more profiles.

At 508, the CCF 202-g and the API invoker 206-h may establish a TLS communication session. For example, mutual authentication based on client and server certificates may be established using TLS between the API invoker 206-h and the CCF 202-g. The client certificate provided to the API invoker 206-h as the result of successful onboarding is used for API invoker authentication.

At 510, the CCF 202-g receives a security method request (e.g., first signaling) from the API invoker 206-h. For example, the API invoker 206-h may send CAPIF-2 and/or CAPIF-2e security capability information to the CCF 202-g in the security method request message. The security capability information may include, but is not limited to, a list of security methods that the API invoker 206-h supports over the CAPIF-2 and/or the CAPIF-2e interface (e.g., reference point) for each AEF and the third-party or designated CCF IDs or addresses associated with each AEF (e.g., when the AEF belongs to a third-party CAPIF provider or belongs to a different CCF, including the CCF 202-h, than the CCF 202-g that onboarded the API invoker 206-h). The security method request may include respective CCF addresses of AEFs, respective CCF IDs of the AEFs, or a URI of the API invoker, or any combination thereof.

At 512, the CCF 202-g may select one or more security methods. For example, the CCF 202-g may select security methods for the API invoker 206-h to use over a CAPIF-2 and/or a CAPIF-2e interface (e.g., reference point) for each requested AEF that belongs to the CCF 202-g, taking into account the information from the API invoker 206-h in the security method request at 510, access scenarios, and AEF capabilities. In some examples, the AEF capabilities may include, but are not limited to, API exposure and invocation handling capabilities (e.g., providing for the AEF to receive and process API requests from API invokers) and supported authentication and authorization mechanisms (e.g., OAuth 2.0, API keys, or certificate-based authentication), among other examples.

At 514, the CCF 202-g may determine a portion of the APIs and/or AEFs requested at 512 by the API invoker 206-h belong to the CCF 202-h. For example, the CCF 202-g may use locally stored information (e.g., from 506) to determine whether the APIs and/or AEFs belong to the CCF 202-h. The CCF 202-g transmits a request to the CCF 202-h for the CCF 202-h to select the security methods to be used over a CAPIF-2 and/or a CAPIF-2e interface (e.g., reference point) for each requested AEF belonging to (e.g., maintained by, implemented by, managed by) the CCF 202-h. The security methods maybe based on one or more service APIs of the CCF 202-h subscribed to by the API invoker 206-h.

At 516, the CCF 202-g may send an interconnect security method request (e.g., second signaling) to the CCF 202-h. For example, the CCF 202-g sends an interconnect security method request to the CCF 202-h that includes an ID of the API invoker 206-h, an ID of the CCF 202-g, a service API of the CCF 202-h that the API invoker 206-h is subscribed to, one or more access scenarios, AEF details (e.g., including the third-party or designed ID or address of the CCF 202-h associated with each AEF), and one or more possible security methods. The security methods may include, but are not limited to, TLS-PSK, TLS-public key infrastructure (PKI), TLS with OAuth token, OAuth client credential flow, authorization code flow, and proof key for code exchange (PKCE) flow, among others.

At 518, the CCF 202-h may select and store one or more security methods. For example, the CCF 202-h checks an access policy to determine whether the CCF 202-g is approved to access the requested security methods for the AEFs of the CCF 202-h. If the CCF 202-g is approved, then the CCF 202-h performs security method selection based on service APIs and/or AEF details subscribed to by the API invoker 206-h, the access scenarios (e.g., whether the API invoker 206-h accesses the AEF prior to service API invocation or upon the service API invocation), and AEF capabilities. The CCF 202-h stores the selected security method per service API and/or AEF for the API invoker ID and stores the ID of the CCF 202-g.

At 520, the CCF 202-h sends an interconnection security method response (e.g., third signaling) to the CCF 202-g. For example, the CCF 202-h sends the interconnection security method response with the chosen security methods and the information for authentication of the API invoker 206-h at the AEF of the CCF 202-h. The information may include a validity time of the CAPIF-2e credentials and a security data sharing criterion (e.g., requirements) indication per AEF.

In some cases, at 522, the CCF 202-g may transmit an interconnection security information notification to the CCF 202-h. For example, the CCF 202-g may send the interconnection security information notification with the API invoker ID, API invoker URI, CAPIF-2 and/or CAPIF-2e security information for each of the service API and/or AEF based on the selected security method (e.g., selected at 518). CAPIF-2 and/or CAPIF-2e security information may include, but is not limited to, a client certificate of the API invoker 206-h, a root certificate of a CA to validate the client certificate of the API invoker 206-h (e.g., if the selected method is using PKI for CAPIF-2 and/or CAPIF-2e authentication and authorization), an AEF PSK (e.g., if the selected method is using TLS-PSK for CAPIF-2 and/or CAPIF-2e authentication and authorization), a root CA certificate of the API invoker 206-h to validate the certificate of the API invoker 206-h (e.g., AEF PSK if the selected method is TLS with OAuth Token for CAPIF-2 and/or CAPIF-2e authentication and authorization).

In some examples, at 524, the CCF 202-h may store the security information. For example, the CCF 202-h stores the received CAPIF-2 and/or CAPIF-2e security information for each of the service API and/or AEF for the selected security method, the ID of the API invoker 206-h, and the URI of the API invoker 206-h.

In some cases, at 526, the CCF 202-h may transmit an interconnection security notification acknowledgement to the CCF 202-g. For example, the CCF 202-h sends the interconnection security information notification acknowledgement with a success indication if the security information is successful received and stored (e.g., at 522 and at 524). Otherwise, the CCF 202-h sends a failure indication.

At 528, the CCF 202-g sends a security method response (e.g., fourth signaling) to the API invoker 206-h. The security method response message includes an indication of the selected security method for each AEF, the third-party or designed ID or address of CCFs associated with each AEF, a security data sharing criterion indication per AEF, and/or security information related to the security method. The API invoker use this method in the subsequent communication establishment with the API exposing function over CAPIF-2 and/or CAPIF-2e reference point. The CCF 202-g also stores the security data sharing criterion indication per AEF for the API invoker to facilitate the security information from CCF 202-g to CCF 202-h for the CAPIF-2/CAPIF-2e security establishment between the API invoker and the AEF in the CCF 202-h domain.

At 530, the API invoker 206-h stores the details (e.g., information, data) from the security method response. For example, the API invoker 206-h stores the AEF details, the third-party or designated IDs and addresses of the CCFs, the selected security method and security information, and the security data sharing criterion indication per AEF. Based on the security data sharing criterion indication per AEF, the API invoker 206-h may initiate authentication data transfer between CCFs (e.g., the CCF 202-g and the CCF 202-h) before the CAPIF-2 and/or CAPIF-2e authentication and authorization or service API invocation, respectively.

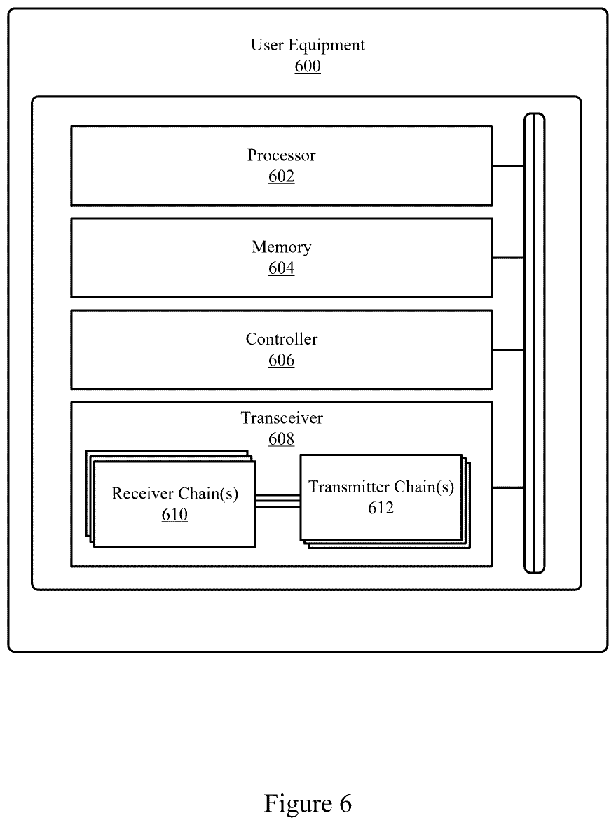

FIG. 6 illustrates an example of a UE 600 in accordance with aspects of the present disclosure. The UE 600 may include a processor 602, a memory 604, a controller 606, and a transceiver 608. The processor 602, the memory 604, the controller 606, or the transceiver 608, or various combinations thereof or various components thereof may be examples of means for performing various aspects of the present disclosure as described herein. These components may be coupled (e.g., operatively, communicatively, functionally, electronically, electrically) via one or more interfaces.

The processor 602, the memory 604, the controller 606, or the transceiver 608, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 602 may include an intelligent hardware device (e.g., a general-purpose processor, a DSP, a CPU, an ASIC, an FPGA, or any combination thereof). In some implementations, the processor 602 may be configured to operate the memory 604. In some other implementations, the memory 604 may be integrated into the processor 602. The processor 602 may be configured to execute computer-readable instructions stored in the memory 604 to cause the UE 600 to perform various functions of the present disclosure.

The memory 604 may include volatile or non-volatile memory. The memory 604 may store computer-readable, computer-executable code including instructions when executed by the processor 602 cause the UE 600 to perform various functions described herein. The code may be stored in a non-transitory computer-readable medium such as the memory 604 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 602 and the memory 604 coupled with the processor 602 may be configured to cause the UE 600 to perform one or more of the functions described herein (e.g., executing, by the processor 602, instructions stored in the memory 604). For example, the processor 602 may support wireless communication at the UE 600 in accordance with examples as disclosed herein. The UE 600 may implement an API invoker and may be configured to or operable to support a means for establishing a connection between the API invoker and a first CCF, transmitting a request to onboard the API invoker to access at least one of one or more service APIs associated with the first CCF or one or more service APIs associated with a second CCF, where the one or more service APIs associated with the first CCF and the one or more service APIs associated with the second CCF correspond to respective CCF addresses or respective CCF IDs, and receiving a response to the request that indicates one or more of the respective CCF addresses or the respective CCF IDs corresponding to the one or more service APIs associated with the first CCF and the one or more service APIs associated with the second CCF.

Additionally, the UE 600 may be configured to support any one or combination of means for storing, at the API invoker, the respective CCF addresses or the respective CCF IDs corresponding to the one or more service APIs associated with the first CCF and the one or more service APIs associated with the second CCF. Additionally, or alternatively, the response to the request includes a profile associated with the API invoker, and where the profile indicates a method for the API invoker to authenticate and authorize one or more AEFs. Additionally, or alternatively, the one or more AEFs are associated with the second CCF, and where the response includes one or more of AEF information associated with the one or more AEFs, additional respective CCF addresses or additional respective CCF IDs corresponding to the one or more AEFs, respective security methods corresponding to the one or more AEFs, or additional respective security methods corresponding to the one or more service APIs associated with the second CCF. Additionally, or alternatively, the profile includes a certificate associated with the API invoker for subsequent authentication procedures with the first CCF and for establishing a connection with the one or more AEFs. Additionally, or alternatively, the response includes one or more of an ID assigned to the API invoker by the first CCF, additional respective CCF addresses or additional respective CCF IDs corresponding to one or more AEFs associated with at least one of the first CCF or the second CCF, a root certificate to validate one or more server certificates corresponding to the one or more AEFs, a certificate associated with the API invoker, and an onboard secret associated with the API invoker.

Additionally, or alternatively, the UE 600 may support at least one memory (e.g., the memory 604) and at least one processor (e.g., the processor 602) coupled with the at least one memory and configured to cause the UE to establish a connection between the API invoker and a first CCF, transmit a request to onboard the API invoker to access at least one of one or more service APIs associated with the first CCF or one or more service APIs associated with a second CCF, where the one or more service APIs associated with the first CCF and the one or more service APIs associated with the second CCF correspond to respective CCF addresses or respective CCF IDs, and receive a response to the request that indicates one or more of the respective CCF addresses or the respective CCF IDs corresponding to the one or more service APIs associated with the first CCF and the one or more service APIs associated with the second CCF.

Additionally, the UE 600 may be configured to support any one or combination of to store, at the API invoker, the respective CCF addresses or the respective CCF IDs corresponding to the one or more service APIs associated with the first CCF and the one or more service APIs associated with the second CCF. Additionally, or alternatively, the response to the request includes a profile associated with the API invoker, and where the profile indicates a method for the API invoker to authenticate and authorize one or more AEFs. Additionally, or alternatively, the one or more AEFs are associated with the second CCF, and where the response includes one or more of AEF information associated with the one or more AEFs, additional respective CCF addresses or additional respective CCF IDs corresponding to the one or more AEFs, respective security methods corresponding to the one or more AEFs, or additional respective security methods corresponding to the one or more service APIs associated with the second CCF. Additionally, or alternatively, the profile includes a certificate associated with the API invoker for subsequent authentication procedures with the first CCF and for establishing a connection with the one or more AEFs. Additionally, or alternatively, the response includes one or more of an ID assigned to the API invoker by the first CCF, additional respective CCF addresses or additional respective CCF IDs corresponding to one or more AEFs associated with at least one of the first CCF or the second CCF, a root certificate to validate one or more server certificates corresponding to the one or more AEFs, a certificate associated with the API invoker, and an onboard secret associated with the API invoker.

The controller 606 may manage input and output signals for the UE 600. The controller 606 may also manage peripherals not integrated into the UE 600. In some implementations, the controller 606 may utilize an operating system such as iOS®, ANDROID®, WINDOWS®, or other operating systems. In some implementations, the controller 606 may be implemented as part of the processor 602.

In some implementations, the UE 600 may include at least one transceiver 608. In some other implementations, the UE 600 may have more than one transceiver 608. The transceiver 608 may represent a wireless transceiver. The transceiver 608 may include one or more receiver chains 610, one or more transmitter chains 612, or a combination thereof.

A receiver chain 610 may be configured to receive signals (e.g., control information, data, packets) over a wireless medium. For example, the receiver chain 610 may include one or more antennas to receive a signal over the air or wireless medium. The receiver chain 610 may include at least one amplifier (e.g., a low-noise amplifier (LNA)) configured to amplify the received signal. The receiver chain 610 may include at least one demodulator configured to demodulate the receive signal and obtain the transmitted data by reversing the modulation technique applied during transmission of the signal. The receiver chain 610 may include at least one decoder for decoding the demodulated signal to receive the transmitted data.

A transmitter chain 612 may be configured to generate and transmit signals (e.g., control information, data, packets). The transmitter chain 612 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 612 may also include at least one power amplifier configured to amplify the modulated signal to an appropriate power level suitable for transmission over the wireless medium. The transmitter chain 612 may also include one or more antennas for transmitting the amplified signal into the air or wireless medium.

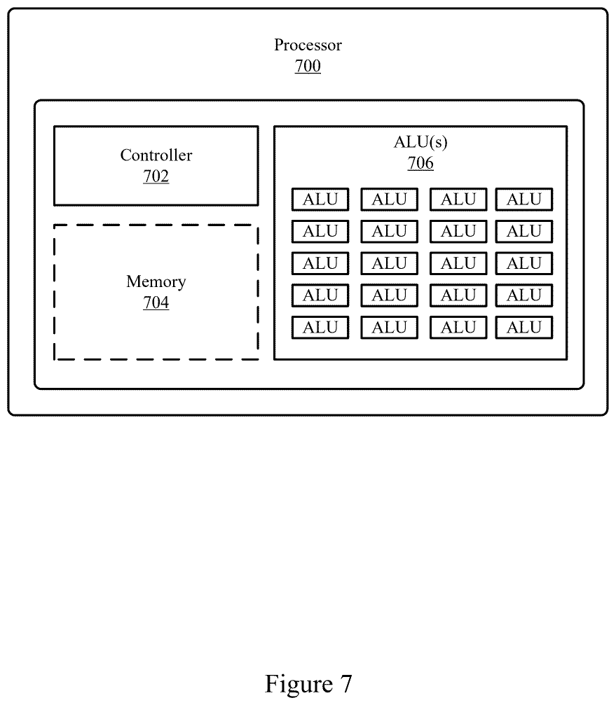

FIG. 7 illustrates an example of a processor 700 in accordance with aspects of the present disclosure. The processor 700 may be an example of a processor configured to perform various operations in accordance with examples as described herein. The processor 700 may include a controller 702 configured to perform various operations in accordance with examples as described herein. The processor 700 may optionally include at least one memory 704, which may be, for example, an L1/L2/L3 cache. Additionally, or alternatively, the processor 700 may optionally include one or more arithmetic-logic units (ALUs) 706. One or more of these components may be in electronic communication or otherwise coupled (e.g., operatively, communicatively, functionally, electronically, electrically) via one or more interfaces (e.g., buses).

The processor 700 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 700) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 702 may be configured to manage and coordinate various operations (e.g., signaling, receiving, obtaining, retrieving, transmitting, outputting, forwarding, storing, determining, identifying, accessing, writing, reading) of the processor 700 to cause the processor 700 to support various operations in accordance with examples as described herein. For example, the controller 702 may operate as a control unit of the processor 700, generating control signals that manage the operation of various components of the processor 700. These control signals include enabling or disabling functional units, selecting data paths, initiating memory access, and coordinating timing of operations.

The controller 702 may be configured to fetch (e.g., obtain, retrieve, receive) instructions from the memory 704 and determine subsequent instruction(s) to be executed to cause the processor 700 to support various operations in accordance with examples as described herein. The controller 702 may be configured to track memory addresses of instructions associated with the memory 704. The controller 702 may be configured to decode instructions to determine the operation to be performed and the operands involved. For example, the controller 702 may be configured to interpret the instruction and determine control signals to be output to other components of the processor 700 to cause the processor 700 to support various operations in accordance with examples as described herein. Additionally, or alternatively, the controller 702 may be configured to manage flow of data within the processor 700. The controller 702 may be configured to control transfer of data between registers, ALUs 706, and other functional units of the processor 700.

The memory 704 may include one or more caches (e.g., memory local to or included in the processor 700 or other memory, such as RAM, ROM, DRAM, SDRAM, SRAM, MRAM, flash memory, etc. In some implementations, the memory 704 may reside within or on a processor chipset (e.g., local to the processor 700). In some other implementations, the memory 704 may reside external to the processor chipset (e.g., remote to the processor 700).

The memory 704 may store computer-readable, computer-executable code including instructions that, when executed by the processor 700, cause the processor 700 to perform various functions described herein. The code may be stored in a non-transitory computer-readable medium such as system memory or another type of memory. The controller 702 and/or the processor 700 may be configured to execute computer-readable instructions stored in the memory 704 to cause the processor 700 to perform various functions. For example, the processor 700 and/or the controller 702 may be coupled with or to the memory 704, the processor 700, and the controller 702, and may be configured to perform various functions described herein. In some examples, the processor 700 may include multiple processors and the memory 704 may include multiple memories. One or more of the multiple processors may be coupled with one or more of the multiple memories, which may, individually or collectively, be configured to perform various functions herein.

The one or more ALUs 706 may be configured to support various operations in accordance with examples as described herein. In some implementations, the one or more ALUs 706 may reside within or on a processor chipset (e.g., the processor 700). In some other implementations, the one or more ALUs 706 may reside external to the processor chipset (e.g., the processor 700). One or more ALUs 706 may perform one or more computations such as addition, subtraction, multiplication, and division on data. For example, one or more ALUs 706 may receive input operands and an operation code, which determines an operation to be executed. One or more ALUs 706 may be configured with a variety of logical and arithmetic circuits, including adders, subtractors, shifters, and logic gates, to process and manipulate the data according to the operation. Additionally, or alternatively, the one or more ALUs 706 may support logical operations such as AND, OR, exclusive-OR (XOR), not-OR (NOR), and not-AND (NAND), enabling the one or more ALUs 706 to handle conditional operations, comparisons, and bitwise operations.

The processor 700 may support wireless communication in accordance with examples as disclosed herein. The processor 700 may be configured to or operable to support at least one controller (e.g., the controller 702) coupled with at least one memory (e.g., the memory 704) and configured to cause the processor to establish a connection between the API invoker and a first CCF, transmit a request to onboard the API invoker to access at least one of one or more service APIs associated with the first CCF or one or more service APIs associated with a second CCF, where the one or more service APIs associated with the first CCF and the one or more service APIs associated with the second CCF correspond to respective CCF addresses or respective CCF IDs, and receive a response to the request that indicates one or more of the respective CCF addresses or the respective CCF IDs corresponding to the one or more service APIs associated with the first CCF and the one or more service APIs associated with the second CCF.

Additionally, the processor 700 may be configured to or operable to support any one or combination of to store, at the API invoker, the respective CCF addresses or the respective CCF IDs corresponding to the one or more service APIs associated with the first CCF and the one or more service APIs associated with the second CCF. Additionally, or alternatively, the response to the request includes a profile associated with the API invoker, and where the profile indicates a method for the API invoker to authenticate and authorize one or more AEFs. Additionally, or alternatively, the one or more AEFs are associated with the second CCF, and where the response includes one or more of AEF information associated with the one or more AEFs, additional respective CCF addresses or additional respective CCF IDs corresponding to the one or more AEFs, respective security methods corresponding to the one or more AEFs, or additional respective security methods corresponding to the one or more service APIs associated with the second CCF. Additionally, or alternatively, the profile includes a certificate associated with the API invoker for subsequent authentication procedures with the first CCF and for establishing a connection with the one or more AEFs. Additionally, or alternatively, the response includes one or more of an ID assigned to the API invoker by the first CCF, additional respective CCF addresses or additional respective CCF IDs corresponding to one or more AEFs associated with at least one of the first CCF or the second CCF, a root certificate to validate one or more server certificates corresponding to the one or more AEFs, a certificate associated with the API invoker, and an onboard secret associated with the API invoker.

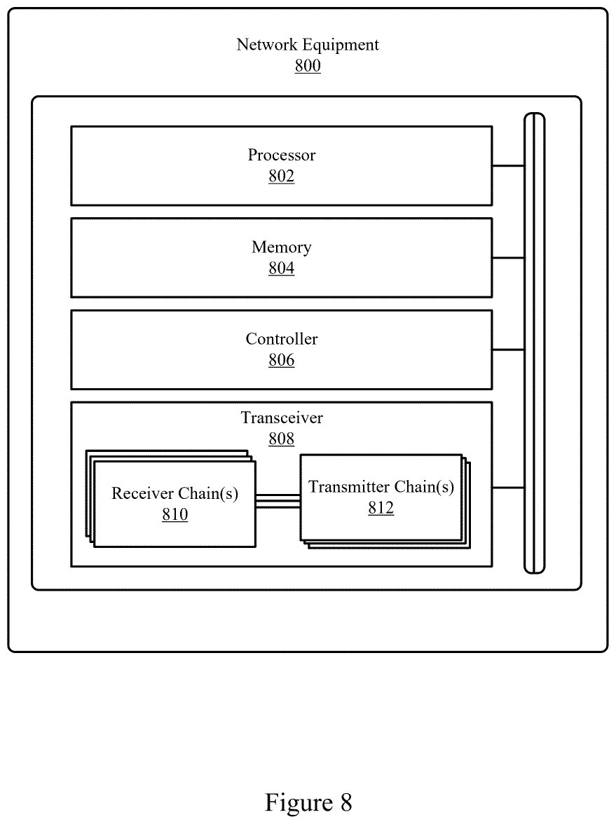

FIG. 8 illustrates an example of an NE 800 in accordance with aspects of the present disclosure. The NE 800 may include a processor 802, a memory 804, a controller 806, and a transceiver 808. The processor 802, the memory 804, the controller 806, or the transceiver 808, or various combinations thereof or various components thereof may be examples of means for performing various aspects of the present disclosure as described herein. These components may be coupled (e.g., operatively, communicatively, functionally, electronically, electrically) via one or more interfaces.

The processor 802, the memory 804, the controller 806, or the transceiver 808, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 802 may include an intelligent hardware device (e.g., a general-purpose processor, a DSP, a CPU, an ASIC, an FPGA, or any combination thereof). In some implementations, the processor 802 may be configured to operate the memory 804. In some other implementations, the memory 804 may be integrated into the processor 802. The processor 802 may be configured to execute computer-readable instructions stored in the memory 804 to cause the NE 800 to perform various functions of the present disclosure.

The memory 804 may include volatile or non-volatile memory. The memory 804 may store computer-readable, computer-executable code including instructions when executed by the processor 802 cause the NE 800 to perform various functions described herein. The code may be stored in a non-transitory computer-readable medium such as the memory 804 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 802 and the memory 804 coupled with the processor 802 may be configured to cause the NE 800 to perform one or more of the functions described herein (e.g., executing, by the processor 802, instructions stored in the memory 804). For example, the processor 802 may support wireless communication at the NE 800 in accordance with examples as disclosed herein. The NE 800 may implement a CCF and may be configured to or operable to support a means for obtaining, based on a connection between the first CCF and a second CCF, an indication that one or more service APIs are associated with the second CCF, receiving a request to onboard an API invoker to access at least one service API of one or more service APIs associated with the first CCF or the one or more service APIs associated with the second CCF, where the one or more service APIs associated with the first CCF and the one or more service APIs associated with the second CCF correspond to respective CCF addresses or respective CCF IDs, and transmitting a response to the request that indicates one or more of the respective CCF addresses or the respective CCF IDs corresponding to the one or more service APIs associated with the first CCF and the one or more service APIs associated with the second CCF.

Additionally, the NE 800 may be configured to or operable to support any one or combination of means for storing, at the first CCF, one or more of the respective CCF addresses or the respective CCF IDs corresponding to the one or more service APIs associated with the first CCF and the one or more service APIs associated with the second CCF, one or more additional respective CCF addresses or one or more additional respective CCF IDs corresponding to one or more AEFs associated with the second CCF, service API information corresponding to the one or more service APIs associated with the first CCF, service API information corresponding to the one or more service APIs associated with the second CCF, AEF information corresponding to the AEFs associated with the first CCF, or AEF information corresponding to the AEFs associated with the second CCF.

Additionally, or alternatively, to transmit the response to the request, the NE 800 may be configured to or operable to support means for generating a profile associated with the API invoker, where the profile indicates a method for the API invoker to authenticate and authorize one or more AEFs. Additionally, or alternatively, the one or more AEFs are associated with the second CCF, and where the response includes one or more of AEF information associated with the one or more AEFs, additional respective CCF addresses or additional respective CCF IDs corresponding to the one or more AEFs, respective security methods corresponding to the one or more AEFs, or additional respective security methods corresponding to the one or more service APIs associated with the second CCF. Additionally, or alternatively, the profile includes a certificate associated with the API invoker for subsequent authentication procedures with the first CCF and for establishing a connection with the one or more AEFs.

Additionally, or alternatively, the response includes one or more of an ID assigned to the API invoker by the first CCF, additional respective CCF addresses or additional respective CCF IDs corresponding to one or more AEFs associated with at least one of the first CCF or the second CCF, a root certificate to validate one or more server certificates corresponding to the one or more AEFs, a certificate associated with the API invoker, and an onboard secret associated with the API invoker. Additionally, or alternatively, the first CCF and the second CCF are associated with different trust domains. Additionally, or alternatively, the first CCF and the second CCF are associated with a same trust domain. Additionally, or alternatively, the first CCF and the second CCF are associated with different CAPIF providers. Additionally, or alternatively, the first CCF and the second CCF are associated with a same CAPIF provider.

The NE 800 may implement a first CCF and may be configured to or operable to support a means for receiving, from an API invoker, first signaling requesting a security method associated with one or more AEFs for accessing one or more service APIs, where the first signaling includes one or more of respective CCF addresses corresponding to the one or more AEFs, respective CCF IDs corresponding to the one or more AEFs, or a uniform resource ID (URI) associated with the API invoker, transmitting, to a second CCF, second signaling requesting respective security methods corresponding to at least a portion of AEFs of the one or more AEFs based on the respective CCF addresses indicating that the portion of the AEFs is associated with the second CCF, receiving, from the second CCF, third signaling that indicates the respective security methods corresponding to the portion of the AEFs and respective security data sharing criterion corresponding to the portion of the AEFs, and transmitting, to the API invoker, fourth signaling that indicates the respective security methods corresponding to the portion of the AEFs, the respective security data sharing criterion corresponding to the portion of the AEFs, and the respective CCF addresses or the respective CCF IDs corresponding to the portion of the AEFs.

Additionally, the NE 800 may be configured to or operable to support any one or combination of means for obtaining, based on a connection between the first CCF and the second CCF, the respective CCF addresses or the respective CCF IDs corresponding to the AEFs and additional respective CCF addresses or additional respective CCF IDs corresponding to the one or more service APIs, and storing, at the first CCF, one or more of the respective CCF addresses or the respective CCF IDs corresponding to the one or more AEFs, the additional respective CCF addresses or the additional respective CCF IDs corresponding to the one or more service APIs, service API information corresponding to the one or more service APIs, and AEF information corresponding to the one or more AEFs. Additionally, or alternatively, the NE 800 may be configured to or operable to support means for selecting, based on security capability information associated with the API invoker, additional respective security methods corresponding to an additional portion of the one or more AEFs associated with the first CCF, where the first signaling indicates the security capability information associated with the API invoker, and where the fourth signaling indicates the additional respective security methods corresponding to the additional portion of the one or more AEFs, respective security data sharing criterion corresponding to the additional portion of the AEFs, and the respective CCF addresses or the respective CCF IDs corresponding to the additional portion of the AEFs.

Additionally, or alternatively, the NE 800 may be configured to or operable to support means for transmitting, to the second CCF, fifth signaling that includes information, where the information includes at least one of an ID associated with the API invoker, the URI associated with the API invoker, security information to secure respective connections between the API invoker and the portion of the AEFs based on the respective security methods, and receiving, from the second CCF, sixth signaling that indicates the second CCF successfully stores the information. Additionally, or alternatively, the second signaling includes an ID associated with the API invoker, an ID associated with the first CCF, an indication of at least a portion of service APIs associated with the second CCF of the one or more service APIs, one or more access scenarios, the respective CCF addresses or the respective CCF IDs corresponding to the portion of the AEFs, and one or more security methods. Additionally, or alternatively, the third signaling includes a validity time associated with a connection between the API invoker and the portion of the AEFs.

The NE 800 may implement a first CCF and may be configured to or operable to support a means for receiving, from a second CCF, first signaling requesting respective security methods associated with one or more AEFs for an API invoker to access one or more service APIs, where respective CCF addresses or respective CCF IDs corresponding to the one or more AEFs indicate that the one or more AEFs are associated with the first CCF, selecting, based on the second CCF being authorized to access the respective security methods, the respective security methods and respective security data sharing criterion corresponding to the AEFs, and transmitting, to the second CCF, second signaling that indicates the respective security methods corresponding to the one or more AEFs and the respective security data sharing criterion corresponding to the AEFs.

Additionally, the NE 800 may be configured to or operable to support the first signaling includes an ID associated with the API invoker, an ID associated with the second CCF, an indication that the one or more service APIs are associated with the first CCF, one or more access scenarios, the respective CCF addresses or the respective CCF IDs corresponding to the one or more AEFs, and one or more security methods, and where the respective security methods are selected from the one or more security methods based on one or more of the indication of one or more service APIs associated with the first CCF, the one or more access scenarios, or respective capabilities of the one or more AEFs. Additionally, or alternatively, the NE 800 may be configured to or operable to support means for receiving, from the second CCF, third signaling that includes information, where the information includes at least one of an ID associated with the API invoker, a URI associated with the API invoker, security information to secure respective connections between the API invoker and the one or more AEFs based on the respective security methods, storing, at the first CCF, the information, and transmitting, to the second CCF, fourth signaling that indicates the first CCF successfully stores the security information. Additionally, or alternatively, the second signaling includes one or more of a validity time associated with a connection between the API invoker and the one or more AEFs. Additionally, or alternatively, the respective security data sharing criterion corresponding to the AEFs includes security information related to the respective security methods.

Additionally, or alternatively, the NE 800 may support at least one memory (e.g., the memory 804) and at least one processor (e.g., the processor 802) coupled with the at least one memory and configured to cause the NE to obtain, based on a connection between the first CCF and a second CCF, an indication that one or more service APIs are associated with the second CCF, receive a request to onboard an API invoker to access at least one service API of one or more service APIs associated with the first CCF or the one or more service APIs associated with the second CCF, where the one or more service APIs associated with the first CCF and the one or more service APIs associated with the second CCF correspond to respective CCF addresses or respective CCF IDs, and transmit a response to the request that indicates one or more of the respective CCF addresses or the respective CCF IDs corresponding to the one or more service APIs associated with the first CCF and the one or more service APIs associated with the second CCF.

Additionally, the NE 800 may be configured to support any one or combination of to store, at the first CCF, one or more of the respective CCF addresses or the respective CCF IDs corresponding to the one or more service APIs associated with the first CCF and the one or more service APIs associated with the second CCF, one or more additional respective CCF addresses or one or more additional respective CCF IDs corresponding to one or more AEFs associated with the second CCF, service API information corresponding to the one or more service APIs associated with the first CCF, service API information corresponding to the one or more service APIs associated with the second CCF, AEF information corresponding to the AEFs associated with the first CCF, or AEF information corresponding to the AEFs associated with the second CCF.

Additionally, or alternatively, to transmit the response to the request, the NE 800 may be configured to support to generate a profile associated with the API invoker, where the profile indicates a method for the API invoker to authenticate and authorize one or more AEFs. Additionally, or alternatively, the one or more AEFs are associated with the second CCF, and where the response includes one or more of AEF information associated with the one or more AEFs, additional respective CCF addresses or additional respective CCF IDs corresponding to the one or more AEFs, respective security methods corresponding to the one or more AEFs, or additional respective security methods corresponding to the one or more service APIs associated with the second CCF. Additionally, or alternatively, the profile includes a certificate associated with the API invoker for subsequent authentication procedures with the first CCF and for establishing a connection with the one or more AEFs.

Additionally, or alternatively, the response includes one or more of an ID assigned to the API invoker by the first CCF, additional respective CCF addresses or additional respective CCF IDs corresponding to one or more AEFs associated with at least one of the first CCF or the second CCF, a root certificate to validate one or more server certificates corresponding to the one or more AEFs, a certificate associated with the API invoker, and an onboard secret associated with the API invoker. Additionally, or alternatively, the first CCF and the second CCF are associated with different trust domains. Additionally, or alternatively, the first CCF and the second CCF are associated with a same trust domain. Additionally, or alternatively, the first CCF and the second CCF are associated with different CAPIF providers. Additionally, or alternatively, the first CCF and the second CCF are associated with a same CAPIF provider.

Additionally, or alternatively, the NE 800 may support at least one memory (e.g., the memory 804) and at least one processor (e.g., the processor 802) coupled with the at least one memory and configured to cause the NE to receive, from an API invoker, first signaling requesting a security method associated with one or more AEFs for accessing one or more service APIs, where the first signaling includes one or more of respective CCF addresses corresponding to the one or more AEFs, respective CCF IDs corresponding to the one or more AEFs, or a uniform resource ID (URI) associated with the API invoker, transmit, to a second CCF, second signaling requesting respective security methods corresponding to at least a portion of AEFs of the one or more AEFs based on the respective CCF addresses indicating that the portion of the AEFs is associated with the second CCF, receive, from the second CCF, third signaling that indicates the respective security methods corresponding to the portion of the AEFs and respective security data sharing criterion corresponding to the portion of the AEFs, and transmit, to the API invoker, fourth signaling that indicates the respective security methods corresponding to the portion of the AEFs, the respective security data sharing criterion corresponding to the portion of the AEFs, and the respective CCF addresses or the respective CCF IDs corresponding to the portion of the AEFs.

Additionally, the NE 800 may be configured to support any one or combination of to obtain, based on a connection between the first CCF and the second CCF, the respective CCF addresses or the respective CCF IDs corresponding to the AEFs and additional respective CCF addresses or additional respective CCF IDs corresponding to the one or more service APIs, and store, at the first CCF, one or more of the respective CCF addresses or the respective CCF IDs corresponding to the one or more AEFs, the additional respective CCF addresses or the additional respective CCF IDs corresponding to the one or more service APIs, service API information corresponding to the one or more service APIs, and AEF information corresponding to the one or more AEFs. Additionally, or alternatively, the NE 800 may be configured to support to select, based on security capability information associated with the API invoker, additional respective security methods corresponding to an additional portion of the one or more AEFs associated with the first CCF, where the first signaling indicates the security capability information associated with the API invoker, and where the fourth signaling indicates the additional respective security methods corresponding to the additional portion of the one or more AEFs, respective security data sharing criterion corresponding to the additional portion of the AEFs, and the respective CCF addresses or the respective CCF IDs corresponding to the additional portion of the AEFs.

Additionally, or alternatively, the NE 800 may be configured to support to transmit, to the second CCF, fifth signaling that includes information, where the information includes at least one of an ID associated with the API invoker, the URI associated with the API invoker, security information to secure respective connections between the API invoker and the portion of the AEFs based on the respective security methods, and receive, from the second CCF, sixth signaling that indicates the second CCF successfully stores the information. Additionally, or alternatively, the second signaling includes an ID associated with the API invoker, an ID associated with the first CCF, an indication of at least a portion of service APIs associated with the second CCF of the one or more service APIs, one or more access scenarios, the respective CCF addresses or the respective CCF IDs corresponding to the portion of the AEFs, and one or more security methods. Additionally, or alternatively, the third signaling includes a validity time associated with a connection between the API invoker and the portion of the AEFs.

Additionally, or alternatively, the NE 800 may support at least one memory (e.g., the memory 804) and at least one processor (e.g., the processor 802) coupled with the at least one memory and configured to cause the NE to receive, from a second CCF, first signaling requesting respective security methods associated with one or more AEFs for an API invoker to access one or more service APIs, where respective CCF addresses or respective CCF IDs corresponding to the one or more AEFs indicate that the one or more AEFs are associated with the first CCF, select, based on the second CCF being authorized to access the respective security methods, the respective security methods and respective security data sharing criterion corresponding to the AEFs, and transmit, to the second CCF, second signaling that indicates the respective security methods corresponding to the one or more AEFs and the respective security data sharing criterion corresponding to the AEFs.

Additionally, the NE 800 may be configured to support any one or combination of the first signaling includes an ID associated with the API invoker, an ID associated with the second CCF, an indication that the one or more service APIs are associated with the first CCF, one or more access scenarios, the respective CCF addresses or the respective CCF IDs corresponding to the one or more AEFs, and one or more security methods, and where the respective security methods are selected from the one or more security methods based on one or more of the indication of one or more service APIs associated with the first CCF, the one or more access scenarios, or respective capabilities of the one or more AEFs. Additionally, or alternatively, the NE 800 may be configured to support to receive, from the second CCF, third signaling that includes information, where the information includes at least one of an ID associated with the API invoker, a URI associated with the API invoker, security information to secure respective connections between the API invoker and the one or more AEFs based on the respective security methods, store, at the first CCF, the information, and transmit, to the second CCF, fourth signaling that indicates the first CCF successfully stores the security information. Additionally, or alternatively, the second signaling includes one or more of a validity time associated with a connection between the API invoker and the one or more AEFs. Additionally, or alternatively, the respective security data sharing criterion corresponding to the AEFs includes security information related to the respective security methods.

The controller 806 may manage input and output signals for the NE 800. The controller 806 may also manage peripherals not integrated into the NE 800. In some implementations, the controller 806 may utilize an operating system such as iOS®, ANDROID®, WINDOWS®, or other operating systems. In some implementations, the controller 806 may be implemented as part of the processor 802.

In some implementations, the NE 800 may include at least one transceiver 808. In some other implementations, the NE 800 may have more than one transceiver 808. The transceiver 808 may represent a wireless transceiver. The transceiver 808 may include one or more receiver chains 810, one or more transmitter chains 812, or a combination thereof.

A receiver chain 810 may be configured to receive signals (e.g., control information, data, packets) over a wireless medium. For example, the receiver chain 810 may include one or more antennas to receive a signal over the air or wireless medium. The receiver chain 810 may include at least one amplifier (e.g., a low-noise amplifier (LNA)) configured to amplify the received signal. The receiver chain 810 may include at least one demodulator configured to demodulate the receive signal and obtain the transmitted data by reversing the modulation technique applied during transmission of the signal. The receiver chain 810 may include at least one decoder for decoding the demodulated signal to receive the transmitted data.

A transmitter chain 812 may be configured to generate and transmit signals (e.g., control information, data, packets). The transmitter chain 812 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 812 may also include at least one power amplifier configured to amplify the modulated signal to an appropriate power level suitable for transmission over the wireless medium. The transmitter chain 812 may also include one or more antennas for transmitting the amplified signal into the air or wireless medium.

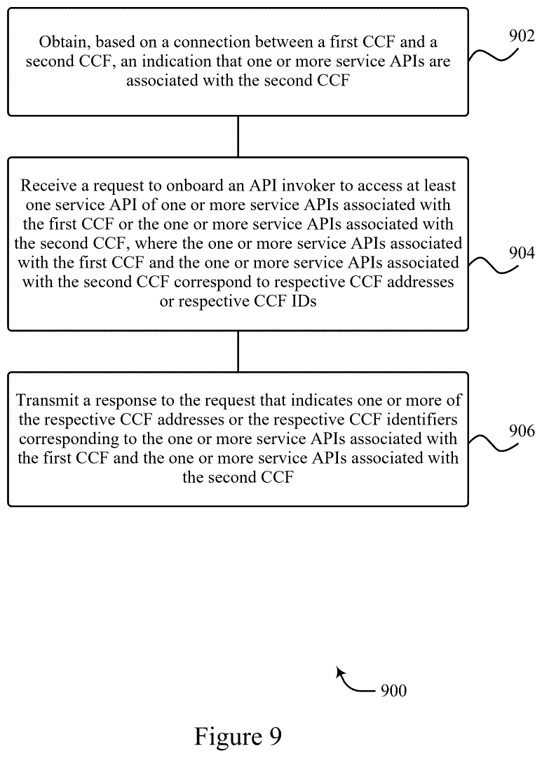

FIG. 9 illustrates a flowchart of a method 900 in accordance with aspects of the present disclosure. The operations of the method may be implemented by a device implementing a CCF as described herein. In some implementations, the device may execute a set of instructions to control the function elements of the device to perform the described functions. It should be noted that the method described herein describes a possible implementation, and that the operations and the steps may be rearranged or otherwise modified and that other implementations are possible.

At 902, the method may include obtaining, based on a connection between a first CCF and a second CCF, an indication that one or more service APIs are associated with the second CCF. The operations of 902 may be performed in accordance with examples as described herein. In some implementations, aspects of the operations of 902 may be performed by a UE as described with reference to FIG. 6 or by an NE as described with reference to FIG. 8.

At 904, the method may include receiving a request to onboard an API invoker to access at least one service API of one or more service APIs associated with the first CCF or the one or more service APIs associated with the second CCF, where the one or more service APIs associated with the first CCF and the one or more service APIs associated with the second CCF correspond to respective CCF addresses or respective CCF IDs. The operations of 904 may be performed in accordance with examples as described herein. In some implementations, aspects of the operations of 904 may be performed by a UE as described with reference to FIG. 6 or by an NE as described with reference to FIG. 8.

At 906, the method may include transmitting a response to the request that indicates one or more of the respective CCF addresses or the respective CCF identifiers corresponding to the one or more service APIs associated with the first CCF and the one or more service APIs associated with the second CCF. The operations of 906 may be performed in accordance with examples as described herein. In some implementations, aspects of the operations of 906 may be performed a UE as described with reference to FIG. 6 or by an NE as described with reference to FIG. 8.

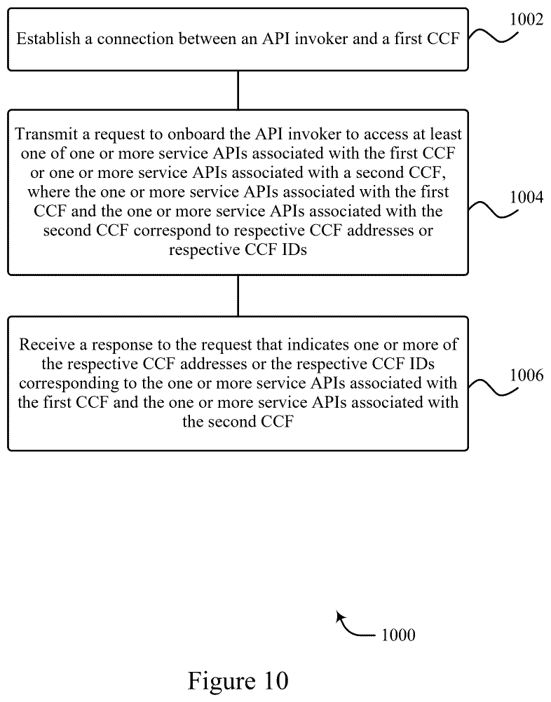

FIG. 10 illustrates a flowchart of a method 1000 in accordance with aspects of the present disclosure. The operations of the method may be implemented by a device implementing an API invoker as described herein. In some implementations, the device may execute a set of instructions to control the function elements of the device to perform the described functions. It should be noted that the method described herein describes a possible implementation, and that the operations and the steps may be rearranged or otherwise modified and that other implementations are possible.

At 1002, the method may include establishing a connection between an API invoker and a first CCF. The operations of 1002 may be performed in accordance with examples as described herein. In some implementations, aspects of the operations of 1002 may be performed by a UE as described with reference to FIG. 6 or by an NE as described with reference to FIG. 8.

At 1004, the method may include transmitting a request to onboard the API invoker to access at least one of one or more service APIs associated with the first CCF or one or more service APIs associated with a second CCF, where the one or more service APIs associated with the first CCF and the one or more service APIs associated with the second CCF correspond to respective CCF addresses or respective CCF IDs. The operations of 1004 may be performed in accordance with examples as described herein. In some implementations, aspects of the operations of 1004 may be performed by a UE as described with reference to FIG. 6 or by an NE as described with reference to FIG. 8.

At 1006, the method may include receiving a response to the request that indicates one or more of the respective CCF addresses or the respective CCF IDs corresponding to the one or more service APIs associated with the first CCF and the one or more service APIs associated with the second CCF. The operations of 1006 may be performed in accordance with examples as described herein. In some implementations, aspects of the operations of 1006 may be performed a UE as described with reference to FIG. 6 or by an NE as described with reference to FIG. 8.

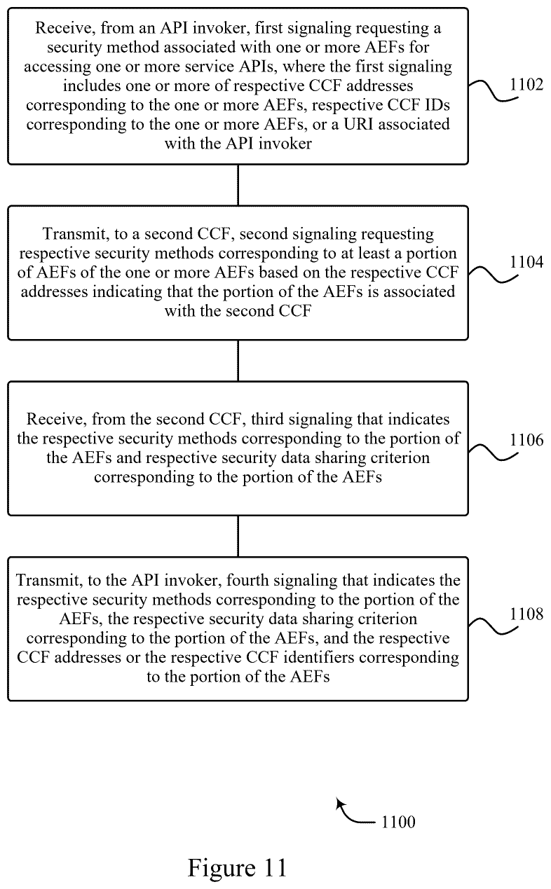

FIG. 11 illustrates a flowchart of a method 1100 in accordance with aspects of the present disclosure. The operations of the method may be implemented by a device implementing a first CCF as described herein. In some implementations, the device may execute a set of instructions to control the function elements of the device to perform the described functions. It should be noted that the method described herein describes a possible implementation, and that the operations and the steps may be rearranged or otherwise modified and that other implementations are possible.

At 1102, the method may include receiving, from an API invoker, first signaling requesting a security method associated with one or more AEFs for accessing one or more service APIs, where the first signaling includes one or more of respective CCF addresses corresponding to the one or more AEFs, respective CCF IDs corresponding to the one or more AEFs, or a URI associated with the API invoker. The operations of 1102 may be performed in accordance with examples as described herein. In some implementations, aspects of the operations of 1102 may be performed by a UE as described with reference to FIG. 6 or by an NE as described with reference to FIG. 8.

At 1104, the method may include transmitting, to a second CCF, second signaling requesting respective security methods corresponding to at least a portion of AEFs of the one or more AEFs based on the respective CCF addresses indicating that the portion of the AEFs is associated with the second CCF. The operations of 1104 may be performed in accordance with examples as described herein. In some implementations, aspects of the operations of 1104 may be performed by a UE as described with reference to FIG. 6 or by an NE as described with reference to FIG. 8.

At 1106, the method may include receiving, from the second CCF, third signaling that indicates the respective security methods corresponding to the portion of the AEFs and respective security data sharing criterion corresponding to the portion of the AEFs. The operations of 1106 may be performed in accordance with examples as described herein. In some implementations, aspects of the operations of 1106 may be performed a UE as described with reference to FIG. 6 or by an NE as described with reference to FIG. 8.

At 1108, the method may include transmitting, to the API invoker, fourth signaling that indicates the respective security methods corresponding to the portion of the AEFs, the respective security data sharing criterion corresponding to the portion of the AEFs, and the respective CCF addresses or the respective CCF identifiers corresponding to the portion of the AEFs. The operations of 1108 may be performed in accordance with examples as described herein. In some implementations, aspects of the operations of 1108 may be performed a UE as described with reference to FIG. 6 or by an NE as described with reference to FIG. 8.

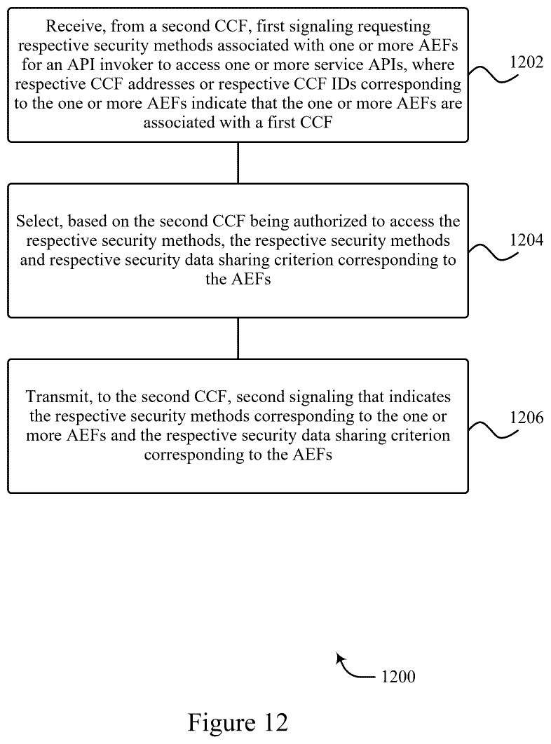

FIG. 12 illustrates a flowchart of a method 1200 in accordance with aspects of the present disclosure. The operations of the method may be implemented by a device implementing a first CCF as described herein. In some implementations, the device may execute a set of instructions to control the function elements of the device to perform the described functions. It should be noted that the method described herein describes a possible implementation, and that the operations and the steps may be rearranged or otherwise modified and that other implementations are possible.

At 1202, the method may include receiving, from a second CCF, first signaling requesting respective security methods associated with one or more AEFs for an API invoker to access one or more service APIs, where respective CCF addresses or respective CCF IDs corresponding to the one or more AEFs indicate that the one or more AEFs are associated with a first CCF. The operations of 1202 may be performed in accordance with examples as described herein. In some implementations, aspects of the operations of 1202 may be performed by a UE as described with reference to FIG. 6 or by an NE as described with reference to FIG. 8.

At 1204, the method may include selecting, based on the second CCF being authorized to access the respective security methods, the respective security methods and respective security data sharing criterion corresponding to the AEFs. The operations of 1204 may be performed in accordance with examples as described herein. In some implementations, aspects of the operations of 1204 may be performed by a UE as described with reference to FIG. 6 or by an NE as described with reference to FIG. 8.

At 1206, the method may include transmitting, to the second CCF, second signaling that indicates the respective security methods corresponding to the one or more AEFs and the respective security data sharing criterion corresponding to the AEFs. The operations of 1206 may be performed in accordance with examples as described herein. In some implementations, aspects of the operations of 1206 may be performed a UE as described with reference to FIG. 6 or by an NE as described with reference to FIG. 8.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A device to implement a first common application programming interface framework core function (CCF) for wireless communication, comprising:
at least one memory; and
at least one processor coupled with the at least one memory and configured to cause the device to:
obtain, based at least in part on a connection between the first CCF and a second CCF, an indication that one or more service application programming interfaces (APIs) are associated with the second CCF;
receive a request to onboard an API invoker to access at least one service API of one or more service APIs associated with the first CCF or the one or more service APIs associated with the second CCF, wherein the one or more service APIs associated with the first CCF and the one or more service APIs associated with the second CCF correspond to respective CCF addresses or respective CCF identifiers; and
transmit a response to the request that indicates one or more of the respective CCF addresses or the respective CCF identifiers corresponding to the one or more service APIs associated with the first CCF and the one or more service APIs associated with the second CCF.

2. The device of claim 1, wherein the at least one processor is further configured to cause the device to store, at the first CCF, one or more of:
the respective CCF addresses or the respective CCF identifiers corresponding to the one or more service APIs associated with the first CCF and the one or more service APIs associated with the second CCF;
one or more additional respective CCF addresses or one or more additional respective CCF identifiers corresponding to one or more application exposure functions (AEFs) associated with the second CCF;
service API information corresponding to the one or more service APIs associated with the first CCF;
service API information corresponding to the one or more service APIs associated with the second CCF;
AEF information corresponding to the AEFs associated with the first CCF; or
AEF information corresponding to the AEFs associated with the second CCF.

3. The device of claim 1, wherein to transmit the response to the request, the at least one processor is configured to generate a profile associated with the API invoker, wherein the profile indicates a method for the API invoker to authenticate and authorize one or more application exposure functions (AEFs).

4. The device of claim 3, wherein the one or more AEFs are associated with the second CCF, and wherein the response comprises one or more of AEF information associated with the one or more AEFs, additional respective CCF addresses or additional respective CCF identifiers corresponding to the one or more AEFs, respective security methods corresponding to the one or more AEFs, or additional respective security methods corresponding to the one or more service APIs associated with the second CCF.

5. The device of claim 3, wherein the profile comprises a certificate associated with the API invoker for subsequent authentication procedures with the first CCF and for establishing a connection with the one or more AEFs.

6. The device of claim 1, wherein the response comprises one or more of an identifier assigned to the API invoker by the first CCF, additional respective CCF addresses or additional respective CCF identifiers corresponding to one or more application exposure functions (AEFs) associated with at least one of the first CCF or the second CCF, a root certificate to validate one or more server certificates corresponding to the one or more AEFs, a certificate associated with the API invoker, and an onboard secret associated with the API invoker.

7. A device to implement an application programming interface (API) invoker for wireless communication, comprising:
at least one memory; and
at least one processor coupled with the at least one memory and configured to cause the device to:
establish a connection between the API invoker and a first common application programming interface framework core function (CCF);
transmit a request to onboard the API invoker to access at least one of one or more service APIs associated with the first CCF or one or more service APIs associated with a second CCF, wherein the one or more service APIs associated with the first CCF and the one or more service APIs associated with the second CCF correspond to respective CCF addresses or respective CCF identifiers; and
receive a response to the request that indicates one or more of the respective CCF addresses or the respective CCF identifiers corresponding to the one or more service APIs associated with the first CCF and the one or more service APIs associated with the second CCF.

8. The device of claim 7, wherein the at least one processor is further configured to cause the device to store, at the API invoker, the respective CCF addresses or the respective CCF identifiers corresponding to the one or more service APIs associated with the first CCF and the one or more service APIs associated with the second CCF.

9. The device of claim 7, wherein the response to the request comprises a profile associated with the API invoker, and wherein the profile indicates a method for the API invoker to authenticate and authorize one or more application exposure functions (AEFs).

10. The device of claim 9, wherein the one or more AEFs are associated with the second CCF, and wherein the response comprises one or more of AEF information associated with the one or more AEFs, additional respective CCF addresses or additional respective CCF identifiers corresponding to the one or more AEFs, respective security methods corresponding to the one or more AEFs, or additional respective security methods corresponding to the one or more service APIs associated with the second CCF.

11. The device of claim 9, wherein the profile comprises a certificate associated with the API invoker for subsequent authentication procedures with the first CCF and for establishing a connection with the one or more AEFs.

12. The device of claim 7, wherein the response comprises one or more of an identifier assigned to the API invoker by the first CCF, additional respective CCF addresses or additional respective CCF identifiers corresponding to one or more application exposure functions (AEFs) associated with at least one of the first CCF or the second CCF, a root certificate to validate one or more server certificates corresponding to the one or more AEFs, a certificate associated with the API invoker, and an onboard secret associated with the API invoker.

13. A device to implement a first common application programming interface framework core function (CCF) for wireless communication, comprising:
at least one memory; and
at least one processor coupled with the at least one memory and configured to cause the device to:
receive, from an application programming interface (API) invoker, first signaling requesting a security method associated with one or more application exposure functions (AEFs) for accessing one or more service APIs, wherein the first signaling comprises one or more of respective CCF addresses corresponding to the one or more AEFs, respective CCF identifiers corresponding to the one or more AEFs, or a uniform resource identifier (URI) associated with the API invoker;
transmit, to a second CCF, second signaling requesting respective security methods corresponding to at least a portion of AEFs of the one or more AEFs based at least in part on the respective CCF addresses indicating that the portion of the AEFs is associated with the second CCF;
receive, from the second CCF, third signaling that indicates the respective security methods corresponding to the portion of the AEFs and respective security data sharing criterion corresponding to the portion of the AEFs; and
transmit, to the API invoker, fourth signaling that indicates the respective security methods corresponding to the portion of the AEFs, the respective security data sharing criterion corresponding to the portion of the AEFs, and the respective CCF addresses or the respective CCF identifiers corresponding to the portion of the AEFs.

14. The device of claim 13, wherein the at least one processor is further configured to:
obtain, based at least in part on a connection between the first CCF and the second CCF, the respective CCF addresses or the respective CCF identifiers corresponding to the AEFs and additional respective CCF addresses or additional respective CCF identifiers corresponding to the one or more service APIs; and
store, at the first CCF, one or more of:
the respective CCF addresses or the respective CCF identifiers corresponding to the one or more AEFs;
the additional respective CCF addresses or the additional respective CCF identifiers corresponding to the one or more service APIs;
service API information corresponding to the one or more service APIs; and
AEF information corresponding to the one or more AEFs.

15. The device of claim 13, wherein the at least one processor is further configured to cause the device to select, based at least in part on security capability information associated with the API invoker, additional respective security methods corresponding to an additional portion of the one or more AEFs associated with the first CCF, wherein the first signaling indicates the security capability information associated with the API invoker, and wherein the fourth signaling indicates the additional respective security methods corresponding to the additional portion of the one or more AEFs, respective security data sharing criterion corresponding to the additional portion of the AEFs, and the respective CCF addresses or the respective CCF identifiers corresponding to the additional portion of the AEFs.

16. The device of claim 13, wherein the at least one processor is further configured to cause the device to:
transmit, to the second CCF, fifth signaling that comprises information, wherein the information comprises at least one of an identifier associated with the API invoker, the URI associated with the API invoker, security information to secure respective connections between the API invoker and the portion of the AEFs based at least in part on the respective security methods; and
receive, from the second CCF, sixth signaling that indicates the second CCF successfully stores the information.

17. The device of claim 13, wherein the second signaling comprises an identifier associated with the API invoker, an identifier associated with the first CCF, an indication of at least a portion of service APIs associated with the second CCF of the one or more service APIs, one or more access scenarios, the respective CCF addresses or the respective CCF identifiers corresponding to the portion of the AEFs, and one or more security methods.

18. A device to implement a first common application programming interface framework core function (CCF) for wireless communication, comprising:
at least one memory; and
at least one processor coupled with the at least one memory and configured to cause the device to:
receive, from a second CCF, first signaling requesting respective security methods associated with one or more application exposure functions (AEFs) for an application programming interface (API) invoker to access one or more service APIs, wherein respective CCF addresses or respective CCF identifiers corresponding to the one or more AEFs indicate that the one or more AEFs are associated with the first CCF;
select, based at least in part on the second CCF being authorized to access the respective security methods, the respective security methods and respective security data sharing criterion corresponding to the AEFs; and
transmit, to the second CCF, second signaling that indicates the respective security methods corresponding to the one or more AEFs and the respective security data sharing criterion corresponding to the AEFs.

19. The device of claim 18, wherein the first signaling comprises an identifier associated with the API invoker, an identifier associated with the second CCF, an indication that the one or more service APIs are associated with the first CCF, one or more access scenarios, the respective CCF addresses or the respective CCF identifiers corresponding to the one or more AEFs, and one or more security methods, and wherein the respective security methods are selected from the one or more security methods based at least in part on one or more of the indication of one or more service APIs associated with the first CCF, the one or more access scenarios, or respective capabilities of the one or more AEFs.

20. The device of claim 18, wherein the at least one processor is further configured to cause the device to:
receive, from the second CCF, third signaling that comprises information, wherein the information comprises at least one of an identifier associated with the API invoker, a uniform resource identifier (URI) associated with the API invoker, security information to secure respective connections between the API invoker and the one or more AEFs based at least in part on the respective security methods;
store, at the first CCF, the information; and
transmit, to the second CCF, fourth signaling that indicates the first CCF successfully stores the security information.
